(19) United States
(12) Patent Application Publication
(10) Pub. No.: US 2026/0275942 A1
(43) Pub. Date: Sep. 17, 2026

(54) SYSTEMS AND METHODS FOR STATIONARY POWER GENERATION USING HYDROGEN AND AMMONIA CO-FUELS

(71) Applicant: First Ammonia Motors, Inc., Concord, NC (US)

(72) Inventors: James L. Wall, II, Concord, NC (US); David Gwynn Kapp, Jr., Concord, NC (US); James Francis Lamb, Concord, NC (US)

(21) Appl. No.: 19/675,801

(22) Filed: May 13, 2026

Related U.S. Application Data
(63) Continuation-in-part of application No. 19/347,959, filed on Oct. 2, 2025.
Application No. 19/347,959 is a continuation of application No. 18/241,321, filed on Sep. 1, 2023, now Pat. No. 12,467,422.
Application No. 18/241,321 is a continuation-in-part of application No. 17/986,265, filed on Nov. 14, 2022, now Pat. No. 11,840,449.
(60) Provisional application No. 63/395,820, filed on Aug. 6, 2022.

(51) Int. Cl. F02M 21/02; C01B 3/047; F02M 21/06; F02M 27/02

(52) U.S. Cl. CPC F02M 21/0227; C01B 3/047; F02M 21/0206; F02M 21/0218; F02M 21/023; F02M 21/06; F02M 27/02; C01B 2203/0277; C01B 2203/0811; C01B 2203/085; C01B 2203/1035; C01B 2203/142

(57) ABSTRACT

The present invention relates, in general, to a stationary power generation system that includes an ammonia supply system, an ammonia cracking system, an internal combustion engine, and a generator. The ammonia cracking system includes an exhaust cracking unit and an electric cracking unit arranged in series. The exhaust cracking unit utilizes engine exhaust heat to crack ammonia, and the electric cracking unit utilizes electrical power to crack ammonia during startup or when exhaust heat is insufficient. Hydrogen resulting from ammonia cracking is supplied to the engine as a co-fuel with ammonia from the ammonia supply system. The internal combustion engine drives the generator to produce electrical power for a load, facility, grid, or microgrid. In some embodiments, the system includes a power system for the electric cracking unit and a fast start system configured to improve startup speed and system readiness.

### CROSS REFERENCE TO RELATED APPLICATIONS

This application is a continuation-in-part of U.S. patent application Ser. No. 19/347,959 entitled “SYSTEMS AND METHODS FOR SUPPLYING GASEOUS AMMONIA TO SERIALLY-CONNECTED AMMONIA CRACKING UNITS” filed on Oct. 2, 2025, which is a continuation of U.S. Pat. No. 11,840,449 entitled “SYSTEMS AND METHODS FOR THE ON-BOARD CATALYTIC PRODUCTION OF HYDROGEN FROM PHASE-CONTROLLED GASEOUS AMMONIA” issued on Nov. 11, 2025, which is a continuation-in-part of U.S. Pat. No. 11,840,449 entitled “SYSTEMS AND METHODS FOR THE CATALYTIC PRODUCTION OF HYDROGEN FROM AMMONIA ON-BOARD MOTOR VEHICLES” issued on Dec. 12, 2023, which claims the benefit of U.S. Provisional Patent Application Ser. No. 63/395,820 entitled “SYSTEMS AND METHODS FOR THE CATALYTIC PRODUCTION OF HYDROGEN FROM AMMONIA ON-BOARD MOTOR VEHICLES” filed on Aug. 6, 2022, U.S. Provisional Patent Application Ser. No. 63/355,959 entitled “SYSTEMS AND METHODS FOR THE CATALYTIC PRODUCTION OF HYDROGEN FROM AMMONIA ON-BOARD MOTOR VEHICLES” filed on Jun. 27, 2022, and U.S. Provisional Patent Application Ser. No. 63/312,121 entitled “SYSTEMS AND METHODS FOR THE CATALYTIC PRODUCTION OF HYDROGEN FROM AMMONIA ON-BOARD MOTOR VEHICLES” filed on Feb. 21, 2022, all of which are commonly owned, the disclosure of each is incorporated herein by reference in their entireties.

### BACKGROUND

### Field of the Invention

The present invention relates, in general, to stationary power generation systems, and more particularly to systems and methods for generating hydrogen by stationary ammonia cracking and supplying the hydrogen and ammonia as co-fuels to an internal combustion engine-generator system.

### Description of Related Art

Reliable stationary power generation is critical to modern infrastructure. Hospitals, data centers, telecommunications facilities, industrial plants, military installations, emergency shelters, water treatment facilities, and commercial buildings all depend on stationary generators to provide standby, backup, prime, or continuous electrical power. In many such applications, compression-ignition diesel generator sets have historically been used because of their durability, fuel availability, and ability to respond quickly to changes in electrical load.

Despite their widespread use, diesel-powered stationary generators present significant environmental drawbacks. The combustion of diesel fuel produces carbon dioxide (CO₂), which contributes to global warming and long-term climate change. In addition, diesel generators can emit nitrogen oxides (NOX), particulate matter, carbon monoxide, unburned hydrocarbons, and other pollutants that can adversely affect air quality and human health, particularly in densely populated areas or in enclosed or semi-enclosed installations. These emissions are of increasing concern in locations where generators are operated for extended periods, such as in prime power, peak shaving, microgrid, and data center backup applications.

Diesel generator systems also present logistical and operational disadvantages. Diesel fuel storage can require large tanks, periodic fuel conditioning, spill containment measures, and ongoing maintenance to address fuel degradation, contamination, and cold-weather operability issues. In emergency backup applications, long-term fuel storage and fuel resupply can become significant concerns, particularly during natural disasters or grid outages. As a result, there is an increasing need for alternative stationary power systems that can reduce carbon emissions while still providing reliable, dispatchable, and fast-start electrical power.

Ammonia has been suggested as an alternative fuel for internal combustion engines because it has relatively high volumetric energy density, can be stored and transported using established infrastructure, and does not itself contain carbon. As a result, combustion of ammonia does not produce CO₂ from the fuel molecule. Ammonia is therefore an attractive energy carrier for stationary power generation, particularly where low-carbon or carbon-free fuels are desired.

However, pure ammonia is difficult to use efficiently as a fuel in many internal combustion engines because ammonia has a relatively low flame speed and a relatively high ignition energy requirement. In stationary generator applications, these combustion characteristics can impair ignition quality, combustion stability, startup performance, transient response, and efficient operation across varying electrical loads. These difficulties can be especially pronounced where the generator is expected to start rapidly, assume load quickly, or maintain stable operation while the engine is held at a substantially constant operating speed.

Prior approaches to operating combustion engines on ammonia have often relied on the use of a secondary combustion-promoting fuel, such as diesel, gasoline, liquefied petroleum gas, or natural gas. While such arrangements may improve ignition and flame propagation, the continued use of a carbon-based pilot or co-fuel reduces the environmental advantages afforded through ammonia fueling.

Hydrogen has also been suggested as a combustion-promoting fuel because hydrogen has a high flame velocity, a low ignition energy, and favorable combustion characteristics. Hydrogen can improve ignition and flame propagation when used with ammonia in an internal combustion engine. However, storing hydrogen as a primary fuel for stationary power generation presents challenges. Hydrogen is a low-density gas that generally requires compression, cooling, or both for practical storage, and dedicated hydrogen storage vessels, piping, and handling systems may increase system complexity, cost, and safety concerns.

It is known that hydrogen can be produced from ammonia by catalytic decomposition into hydrogen and nitrogen through a process commonly referred to as “cracking.” In principle, on-site ammonia cracking can allow a stationary power system to store ammonia in bulk form and generate hydrogen when needed for startup, ignition enhancement, combustion stabilization, or load response. However, ammonia cracking is an endothermic process that requires heat input. In stationary generator applications, this presents practical challenges during startup and low-load operation, when sufficient exhaust heat may not yet be available to drive the cracking process. Fast-start applications, black-start capability, and critical-load deployments may impose even greater demands on the cracking system and associated electrical and thermal support systems.

Accordingly, there remains a need for systems and methods for supplying hydrogen derived from ammonia to stationary internal combustion engine-generator systems in a manner that eliminates reliance on diesel fuel, eliminates carbon emissions, supports rapid startup and reliable load acceptance, and enables stable generator operation across a range of stationary power applications.

### SUMMARY

In an embodiment, the present invention is directed to a stationary power generation system, comprising: an ammonia supply system including an ammonia source, a pressure regulator, and a vaporizer configured to provide gaseous ammonia; an ammonia cracking system fluidly coupled to the ammonia supply system, the ammonia cracking system including an exhaust cracking unit and an electric cracking unit arranged in series along a single ammonia flow path such that gaseous ammonia flows through the exhaust cracking unit before flowing to the electric cracking unit; an internal combustion engine; a generator mechanically coupled to the internal combustion engine; an ammonia supply line configured to supply gaseous ammonia from the ammonia supply system directly to the internal combustion engine; a cracking-gas line configured to supply a hydrogen-containing gas from the ammonia cracking system to the internal combustion engine, wherein the internal combustion engine is configured to operate on the gaseous ammonia and the hydrogen-containing gas as co-fuels; and a control system configured to: (i) during startup, energize the electric cracking unit to generate the hydrogen-containing gas before the exhaust cracking unit reaches a threshold temperature suitable for ammonia cracking using exhaust heat; and (ii) after the exhaust cracking unit reaches the threshold temperature, utilize the exhaust cracking unit for ammonia cracking while maintaining the internal combustion engine at a substantially constant operating speed as electrical load changes.

In another embodiment, the present invention is directed to a method of operating a stationary power generation system, comprising: supplying ammonia from an ammonia source to a pressure regulator and a vaporizer to produce gaseous ammonia; delivering a first portion of the gaseous ammonia directly to an internal combustion engine; delivering a second portion of the gaseous ammonia through an exhaust cracking unit and then through an electric cracking unit arranged in series; during startup, energizing the electric cracking unit so that at least part of the second portion of the gaseous ammonia is cracked into a hydrogen-containing gas before the exhaust cracking unit reaches a threshold temperature suitable for ammonia cracking using exhaust heat; supplying the hydrogen-containing gas to the internal combustion engine together with the first portion of the gaseous ammonia so that the internal combustion engine operates on ammonia and hydrogen-containing gas as co-fuels; driving a generator with the internal combustion engine to produce electrical power; monitoring exhaust temperature; and after the exhaust temperature exceeds the threshold temperature, utilizing the exhaust cracking unit for ammonia cracking and operating the internal combustion engine at a substantially constant operating speed while varying fuel delivery and air flow in response to changes in electrical load.

In yet another embodiment, the present invention is directed to a skid-mounted generator system, comprising: a skid base; an internal combustion engine mounted on the skid base; an alternator or generator head mounted on the skid base and mechanically coupled to the internal combustion engine; an ammonia cracking system integrated with the skid-mounted generator system, the ammonia cracking system including an exhaust cracking unit and an electric cracking unit arranged in series; an exhaust assembly operatively associated with the internal combustion engine and configured to direct exhaust gas from the internal combustion engine to the exhaust cracking unit for use in ammonia cracking; an ammonia supply line configured to supply ammonia to the internal combustion engine; a cracking-gas line configured to supply hydrogen-containing cracking gas from the ammonia cracking system to the internal combustion engine such that the internal combustion engine is configured to operate on ammonia and hydrogen-containing cracking gas as co-fuels; and a control cabinet configured to coordinate operation of the internal combustion engine, the ammonia cracking system, and the alternator or generator head.

### BRIEF DESCRIPTION OF THE DRAWINGS

These and other embodiments of the present invention will be discussed with reference to the following exemplary and non-limiting illustrations, in which like elements are numbered similarly, and where:

FIG. 1 is a perspective internal view of an exchange cracking unit that utilizes a TPMS structure;

FIG. 2 is a perspective internal view of the heat exchange cracking unit that utilizes a TPMS structure which depicts the flow of heated exhaust gas and gaseous ammonia through the matrix;

FIG. 3 is a perspective view of the matrix having a gyroid TPMS structure;

FIG. 4 is a perspective view of the matrix having an orthogonal hole TPMS structure;

FIG. 5 is a perspective view of the matrix having a split pea TPMS structure;

FIG. 6 is a top-down perspective view of the heat exchange cracking unit that utilizes a TPMS structure;

FIG. 7 is a front cross-sectional view of a cylindrical heat exchange cracking unit that utilizes a TPMS structure;

FIG. 8 is a front cross-sectional view of the cylindrical heat exchange cracking unit that utilizes a TPMS structure which depicts the flow of heated exhaust gas and gaseous ammonia through the matrix;

FIG. 9 is a side cross-sectional view of the cylindrical heat exchange cracking unit that utilizes a TPMS structure which depicts the flow of heated exhaust gas and gaseous ammonia through the matrix;

FIG. 10 is a perspective view of a heat exchange cracking unit that utilizes a tube bundle structure;

FIG. 11 is a front cross-sectional view of the heat exchange cracking unit that utilizes a tube bundle structure;

FIG. 12 is a side cross-sectional view of the heat exchange cracking unit that utilizes a tube bundle structure;

FIG. 13 is a front cross-sectional view of a two-pass heat exchange cracking unit that utilizes a tube bundle structure;

FIG. 14 is a block diagram of an on-board ammonia cracking system for an internal combustion engine; and

FIG. 15 is a perspective view of an on-board ammonia cracking system for an internal combustion engine;

FIG. 16 is a top-down perspective view of the on-board ammonia cracking system;

FIG. 17 is a perspective side view of the on-board ammonia cracking system;

FIG. 18 is a perspective view of an electric cracking unit;

FIG. 19 is a cross-sectional view of an electric cracking unit;

FIG. 20 is a block diagram of a stationary power generation system configured to utilize ammonia cracking to supply fuel to an internal combustion engine-generator set;

FIG. 21 is a block diagram of a power system for an electric cracking unit for the stationary power generation system;

FIG. 22 is a block diagram of a fast start system for the stationary power generation system;

FIG. 23 is a flow chart illustrating a normal startup sequence for the stationary power generation system;

FIG. 24 is a flow chart illustrating a fast startup sequence for the stationary power generation system;

FIG. 25 is a flow chart illustrating a steady-state control sequence for the stationary power generation system during operation; and

FIG. 26 is a perspective view of a skid-mounted generator system.

### DEFINITIONS

The following definitions are meant to aid in the description and understanding of the defined terms in the context of the present invention. The definitions are not meant to limit these terms to less than is described throughout this specification. Such definitions are meant to encompass grammatical equivalents.

As used herein, the term “motor vehicle” refers to any moving vehicle that is capable of carrying one or more human occupants and/or cargo, or which is capable of performing a task, and which is powered by any form of energy. The term “motor vehicle” includes, but is not limited to: (a) vehicles such as cars, trucks, vans, minivans, sport utility vehicles, passenger carrying vehicles, goods carrying vehicles, 2-, 3-, and 4-wheeled vehicles, quadricycles, motorcycles, scooters, all-terrain vehicles, utility task vehicles, and the like; (b) airborne vehicles such as helicopters, airplanes, airships, drones, aerospace vehicles, and the like; (c) marine vessels such as dry cargo ships, liquid cargo ships, specialized cargo ships, tug-boats, cruise ships, recreational boats, fishing boats, personal watercraft, jet skis, and the like; (d) locomotives; and (e) heavy equipment and machinery, power generators, lawnmowers and tractors, agricultural equipment and machinery, forestry equipment and machinery, construction equipment and machinery, mining equipment and machinery, and the like.

As used herein, the term “internal combustion engine” refers to any engine, spark ignition gasoline engine, compression ignition diesel engine, rotary, reciprocating, or other engine wherein combustion takes place in a combustion chamber, such that the products of combustion, together with any other by-products, perform work by exerting force on a moving surface from which the mechanical output is obtained from the engine. The term “internal combustion engine” includes, but is not limited to, hybrid internal combustion engines, two-stroke engines, four-stroke engines, six-stroke engines, and the like.

As used herein, the term “catalyst” refers to a material that promotes a chemical reaction. The term “catalyst” includes, but is not limited to, a catalyst or catalysts capable of promoting cracking reactions, such as ammonia cracking reactions, whether used as base catalyst(s) and/or additive catalyst(s). The catalyst, for the purposes of the present invention, can include, but is not limited to, a non-stoichiometric lithium imide, nickel, iron, cobalt, iron cobalt, ruthenium, vanadium, palladium, rhodium, platinum, sodium amide, and the like, as well as various combinations thereof.

As used herein, the term “cracking” refers to a process or processes by which ammonia is decomposed into constituent hydrogen and nitrogen components over at least one catalyst.

As used herein, the terms “cracking unit” and “catalyst unit”, used interchangeably, refer to a reactor assembly, system, or module that is configured to thermally and/or catalytically decompose ammonia into a hydrogen-rich product gas stream comprising hydrogen and nitrogen. The cracking unit may include, but is not limited to, one or more reaction chambers, catalyst beds, heating elements, heat exchangers, flow channels, insulation layers, or integrated subsystems designed to facilitate the dissociation of ammonia.

As used herein, the term “nickel alloy” refers to pure nickel or an alloy containing nickel as a main component. The term “nickel alloy” includes, but is not limited to, Inconel® 625, Inconel® 718, Inconel® 725, and other compound metals having nickel as a main component. Inconel® is the trademark of Special Metals Corporation of Huntington, West Virginia.

As used herein, the term “triply-periodic minimal surface (TPMS)” refers to mathematically defined structures that repeat in three dimensions with zero mean curvatures and large surface areas.

As used herein, the term “generator” refers to a device, machine, assembly, or system configured to convert mechanical energy into electrical energy. The term “generator” includes, but is not limited to, an alternator, a synchronous generator, an asynchronous generator, an induction generator, a direct current generator, a genset, and an engine-generator set, as well as stationary, portable, standby, backup, prime-power, continuous-duty, microgrid, and uninterruptible power supply generator systems, and various combinations thereof.

### DETAILED DESCRIPTION

It should be understood that aspects of the present invention are described herein with reference to the figures, which show illustrative embodiments. The illustrative embodiments herein are not necessarily intended to show all embodiments in accordance with the invention, but rather are used to describe a few illustrative embodiments. Thus, aspects of the invention are not intended to be construed narrowly in view of the illustrative embodiments. In addition, although the present invention is described with respect to its application for an internal combustion engine for a motor vehicle, it is understood that the system could be implemented in any engine-driven setting that may be powered by ammonia and/or hydrogen fuel.

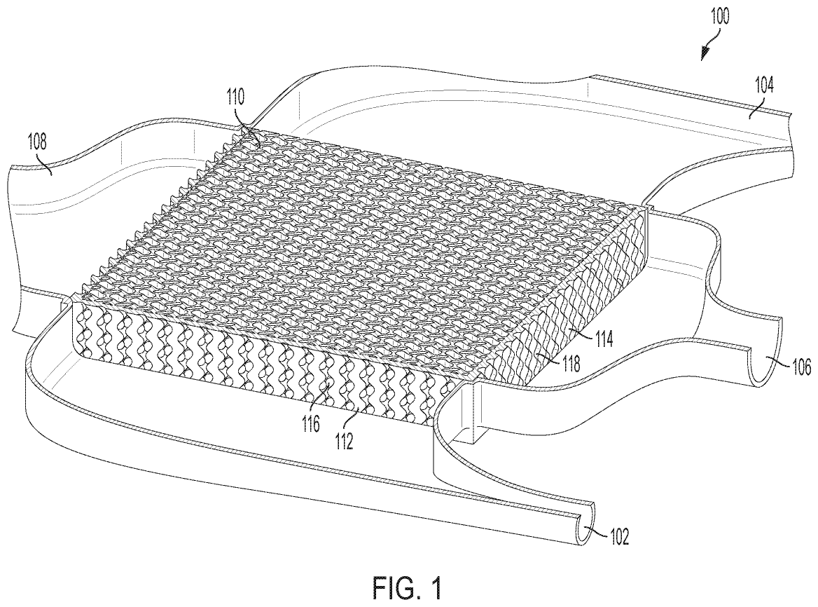

FIG. 1 is a perspective internal view of a heat exchange cracking unit that utilizes a TPMS structure, and which serves as a heat exchanger as well as a catalytic converter that performs ammonia cracking. The heat exchange cracking unit 100 is metallic, and in an embodiment, includes a gaseous ammonia inlet 102, a hydrogen outlet 104, a heated exhaust gas inlet 106, and an exhaust gas outlet 108. In an embodiment, the heat exchange cracking unit 100 is made from a nickel alloy. In a preferred embodiment, the heat exchange cracking unit 100 is made from Inconel® 625.

In an embodiment, the gaseous ammonia inlet 102, the hydrogen outlet 104, the heated exhaust gas inlet 106, and the exhaust gas outlet 108 can be made from the same metallic material as the heat exchange cracking unit 100. In another embodiment, the gaseous ammonia inlet 102, the hydrogen outlet 104, the heated exhaust gas inlet 106, and the exhaust gas outlet 108 can be made from stainless steel, silver, bronze, and comparable alloys.

Positioned between the inlets 102, 106 and outlets 104, 108 is a matrix 110. The matrix 110 is formed from width-wise surfaces 112 and length-wise surfaces 114 which run generally perpendicular to each other. The surfaces 112, 114 of the matrix 110 create passages that allow the gaseous ammonia and heated exhaust gas to flow; these passages are indicated by the ammonia channels 116 and heated exhaust gas channels 118. Gaseous ammonia is supplied to heat exchange cracking unit 100 via inlet 102, while heated exhaust gas is concurrently supplied to inlet 106. The gaseous ammonia traverses the matrix 110 via ammonia channels 116, while the heated exhaust gas traverses the matrix via heated exhaust gas channels 118. The ammonia channels 116 and the heated exhaust gas channels 118 are orientated in a generally perpendicular fashion to one another, such that the gaseous ammonia traverses the matrix 110 at approximate right angles relative to the heated exhaust gas.

In an embodiment, the surfaces 112, 114 have a thickness of 1 to 2 millimeters, and each of the surfaces 112, 114 can have the same thickness. In another embodiment, the surfaces 112, 114 can each have a different thickness. In yet another embodiment, the surfaces 112, 114 may vary in thickness as they each traverse across the matrix 110. For example, the surfaces 112, 114 may not have a uniform thickness across the width of the matrix 110, and may have thicker or narrower portions at various locations.

As shown in FIG. 1, the matrix 110 physically separates the gases passing through each of the channels 116, 118, thereby providing an exceptionally large surface area throughout the matrix 110 where the heated exhaust gas exchanges its heat with the gaseous ammonia. In an embodiment, the surfaces 112, 114 of the matrix 110 are coated with a catalyst that facilitates the cracking of ammonia into constituent hydrogen and nitrogen components. In this embodiment, the surfaces 112, 114 of the matrix 110 are coated with the catalyst using a washcoating or deposition technique to bind or adhere the catalyst to the surfaces 112, 114.

In another embodiment, catalyst in the form of discrete catalyst media is deposited into the passages forming the ammonia channels 116 and heated exhaust gas channels 118. The discrete catalyst media can be porous, allowing the gaseous ammonia and exhaust gas to pass through the catalyst as they each flow through the matrix 110.

In yet another embodiment, the surfaces 112, 114 of the matrix 110 can be coated with a catalyst as described herein, and additional discrete catalyst media can be deposited into the passages forming the ammonia channels 116 and heated exhaust gas channels 118.

In an embodiment, the matrix 110 is metallic, and is made from a nickel alloy. In a preferred embodiment, the matrix 110 is made from Inconel® 625. The heat exchange cracking unit 100 and matrix 110 may be constructed from the same metallic material. In another embodiment, the heat exchange cracking unit 100 and matrix 110 can be constructed from different metallic materials.

The material(s) selected for the heat exchange cracking unit 100 and matrix 110 need to have the ability to withstand the corrosive environment resulting from the high-temperature heated exhaust gas, as well as the heated hydrogen gas which is generated from the cracking of ammonia.

In a preferred embodiment, the matrix 110 is in the form of a triply-periodic minimal surface (TPMS), and the matrix 110 is three-dimensionally (3D) printed using powdered metal. The 3D printing process is an additive manufacturing process that uses laser sintering to selectively fuse together particles of the powdered metal into a TPMS structure in a layer-by-layer strategy. The TPMS structure of the matrix 110 provides for a relatively large surface area comprising cells which can be confined within the dimensions and shape of the heat exchange cracking unit 100.

The TPMS structure can take on a variety of crystalline-like structures which have different patterns and profiles. In the embodiment shown in FIG. 1, the TPMS is a gyroid structure. The structures can be in the form of, but are not limited to, gyroid, diamond, orthogonal holes, split pea, among many others. Each of these forms has a different surface area. For example, in the embodiment shown in FIG. 1, the heat exchange cracking unit 100 has dimensions of approximately 10×10×4 inches. For a matrix 110 which fits within these dimensions, Table 1 provides approximate surface area values for the various TPMS structure that may be utilized:

TABLE 1

| Structure | Surface Area (million millimeters²) |
|---|---|
| Gyroid | 1.5 million mm² |
| Orthogonal holes | 1.6 million mm² |
| Split pea | 2.1 million mm² |
| Diamond | 2.5 million mm² |

It is noted however, that the values in Table 1 are illustrative examples only and are not intended to be in any way limiting. The individual cell sizes of the TPMS can be modified to increase or decrease the surface area of the matrix 110. For example, within the same volume of the heat exchange cracking unit 100, the individual cell size can be increased to increase the overall surface area of the matrix 110, and conversely, the individual cell size can be decreased to decrease the overall surface area of the matrix 110.

The TPMS structure is ideal for the matrix 110 as it allows heat to be distributed to all surfaces of the matrix 100, thereby facilitating the chemical reaction required for the ammonia cracking process. As the surface area of the matrix 110 increases, there is an inherent challenge in cleaning the surfaces of the matrix 110 after it is printed, given that the formation of the channels 116, 118 become narrower relative to one another as the surface area increases. However, as the cell size of the matrix 110 increases, the surface area decreases, which decreases the throughput efficiency of the heat exchange cracking unit 100. The surface area of the matrix 110 can depend on the power requirements of the motor vehicle and its engine.

In an embodiment, the heat exchange cracking unit 100 is sized and dimensioned to accommodate a matrix 110 with sufficient surface area to facilitate the cracking process, while still having a form factor that is suitable for placement within a motor vehicle. The dimensions of the heat exchange cracking unit 100 can vary, and can range from 5 to 30 inches in width, 5 to 30 inches in length, and 0.5 to 12 inches in height.

In an embodiment, the heat exchange cracking unit 100 has a generally square shape which accommodates a square-shaped matrix 110, as shown in FIG. 1, which is an illustrative example only and is not intended to be in any way limiting. In other embodiments, the heat exchange cracking unit 100 can be any polygonal shape, such as, for example, oval, oblong, triangular, square, kite-shaped, trapezoid, parallelogram, rhombus, and the like, as well as various 3D shapes such as, for example, cube, cuboid, sphere, cone, and the like.

In an embodiment, the ammonia inlet 102 has a smaller diameter than the heated exhaust gas inlet 106, as the exhaust gas flow rate may be orders of magnitude higher than the ammonia flow rate. As with the dimensions of the heat exchange cracking unit 100, the diameters, shape, and sizes of the inlets 102, 106, and outlets 104, 108 can vary based on the power requirements of the motor vehicle and its engine.

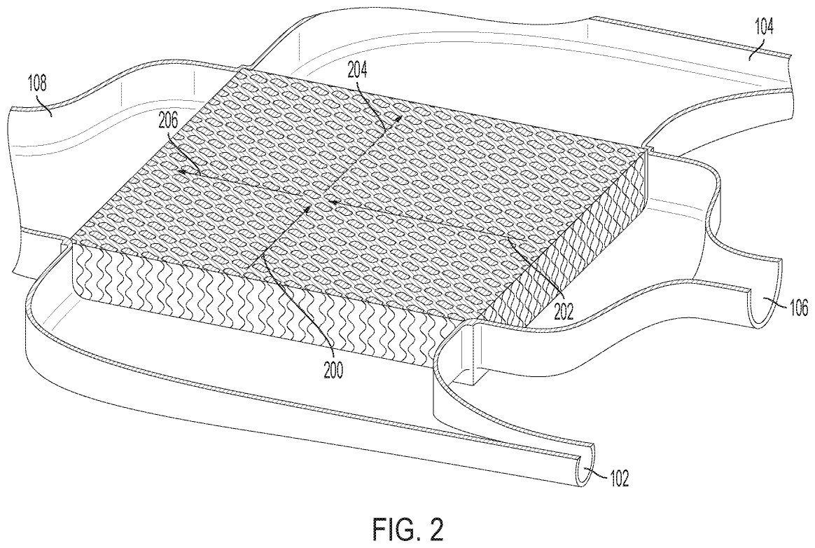

FIG. 2 is a perspective internal view of the heat exchange cracking unit 100 that utilizes a TPMS structure which depicts the flow of heated exhaust gas and gaseous ammonia through the matrix. In operation, gaseous ammonia 200 is supplied to the inlet 102 and flows through the ammonia channels 116, while heated exhaust gas 202 is concurrently supplied to the inlet 106 and flows through the heated gas channels 118. The heated exhaust gas 202 heats the catalyst, resulting in cracking of the gaseous ammonia 200 into constituent hydrogen and nitrogen components 204. The resulting hydrogen and nitrogen components 204 exit the heat exchange cracking unit 100 via the outlet 104 and are supplied to the downstream injection system for the engine, while residual exhaust gas 206 exits the heat exchange cracking unit via the outlet 108.

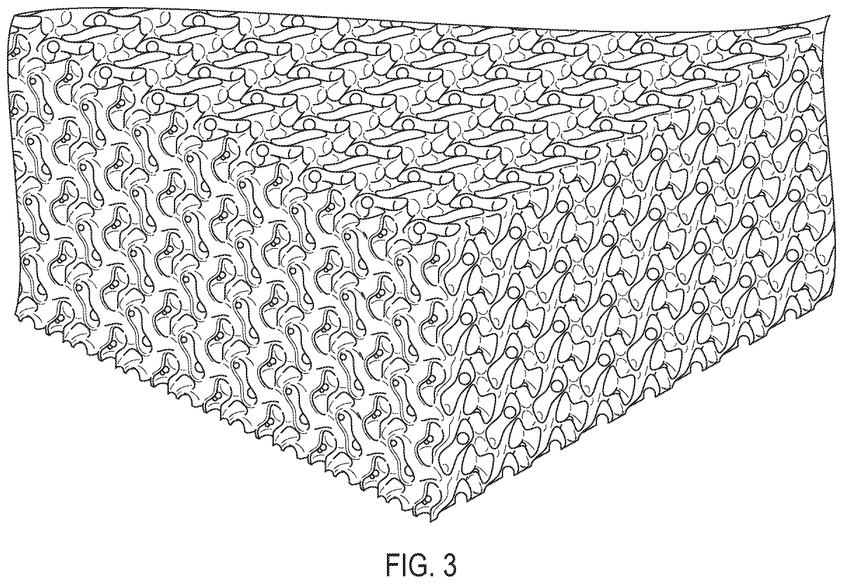

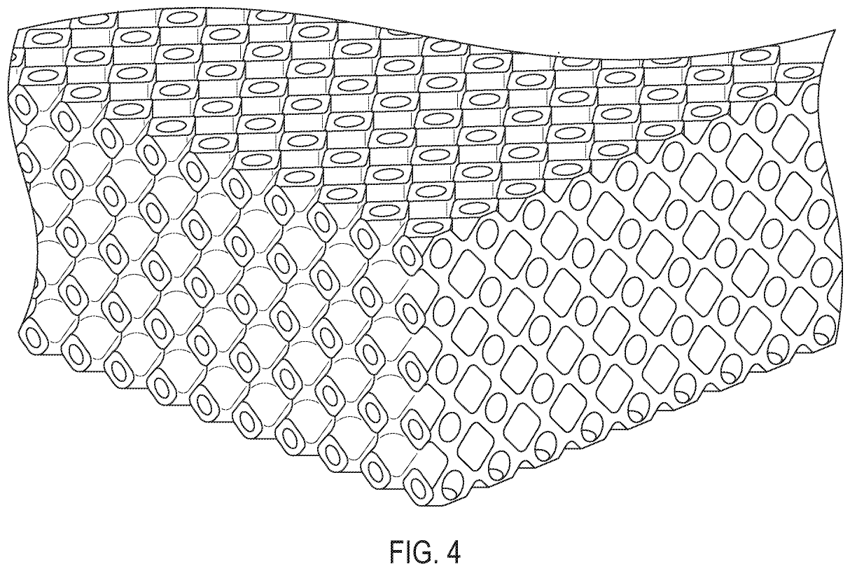

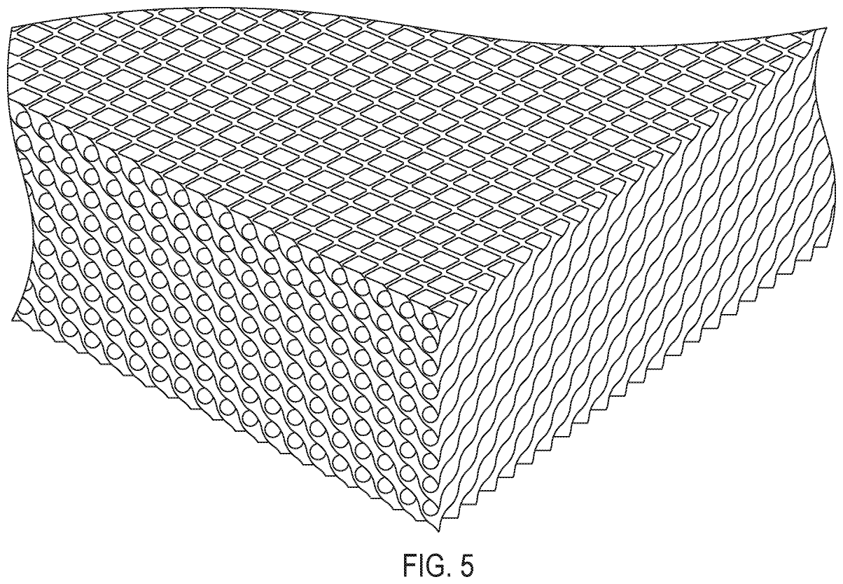

FIG. 3 is a perspective view of the matrix 110 having a gyroid TPMS structure, FIG. 4 is a perspective view of the matrix 110 having an orthogonal hole TPMS structure, and FIG. 5 is a perspective view of the matrix 110 having a split pea TPMS structure. It is noted however, that the TPMS structures depicted in FIGS. 1 through 5 are illustrative examples only and are not intended to be in any way limiting.

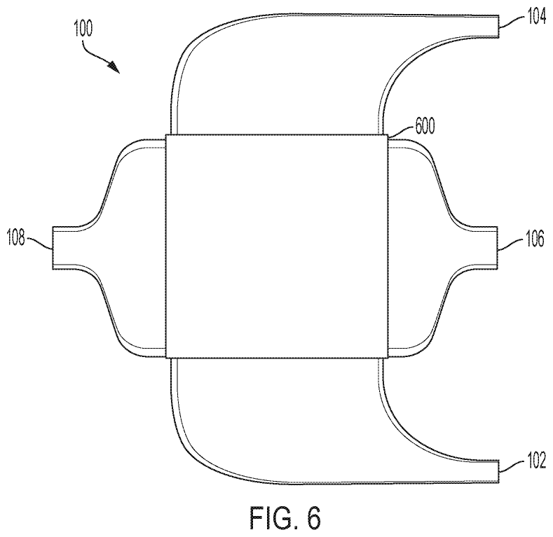

FIG. 6 is a top-down perspective view of the heat exchange cracking unit 100 that utilizes a TPMS structure. In an embodiment, the heat exchange cracking unit 100 can be manufactured via welding the inlets 102, 106 and outlets 104, 108 to a housing 600. In an embodiment, the housing 600 can include a cover (not depicted in FIG. 6) which can be removed in order to service or replace the matrix 110. In another embodiment, the inlets 102, 106 and/or the outlets 104, 108 can be removably attached to the housing 600 so that different inlets and outlets having various dimensions, sizes, and flow properties can be utilized with the housing 600 in a modular fashion.

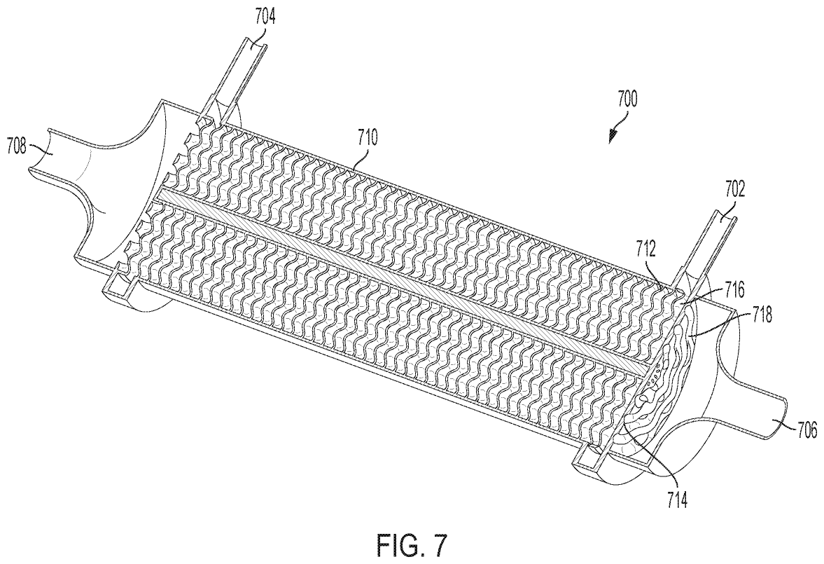

FIG. 7 is a front cross-sectional view of a cylindrical heat exchange cracking unit 700 that utilizes a TPMS structure. Similar to the heat exchange cracking unit 100 shown in FIG. 1, the cylindrical heat exchange cracking unit 700 is metallic and made from a nickel alloy, and in a preferred embodiment, the cylindrical heat exchange cracking unit 700 is made from Inconel® 625.

In an embodiment, the cylindrical heat exchange cracking unit 700 includes an ammonia inlet 702, a hydrogen outlet 704, a heated exhaust gas inlet 706, and an exhaust gas outlet 708. Positioned between the inlets 702, 706 and outlets 704, 708 is a matrix 710. The matrix 710 is formed from width-wise surfaces 712 and length-wise surfaces 714 which run generally perpendicular to each other. The surfaces 712, 714 of the matrix 710 create passages allowing the gaseous ammonia and heated exhaust gas to flow; these passages are indicated by the ammonia channels 716 and heated exhaust gas channels 718.

Gaseous ammonia is supplied to cylindrical heat exchange cracking unit 700 via inlet 702, while heated exhaust gas is concurrently supplied to inlet 706. The gaseous ammonia traverses the matrix 710 axially, while the heated exhaust gas traverses the matrix laterally.

As shown in FIG. 7, the matrix 710 physically separates the gases passing through each of the channels 716, 718, thereby providing an exceptionally large surface area throughout the matrix 710 where the heated exhaust gas exchanges its heat with the gaseous ammonia. In an embodiment, the surfaces 712, 714 of the matrix 710 are coated with a catalyst that facilitates the cracking of ammonia into constituent hydrogen and nitrogen components. In this embodiment, the surfaces 712, 714 of the matrix 710 are coated with the catalyst using a washcoating or deposition technique to bind or adhere the catalyst to the surfaces 712, 714.

In another embodiment, catalyst in the form of discrete catalyst media is deposited into the passages forming the ammonia channels 716 and heated exhaust gas channels 718.

In yet another embodiment, the surfaces 712, 714 of the matrix 710 can be coated with a catalyst as described herein, and additional discrete catalyst media can be deposited into the passages forming the ammonia channels 716 and heated exhaust gas channels 718.

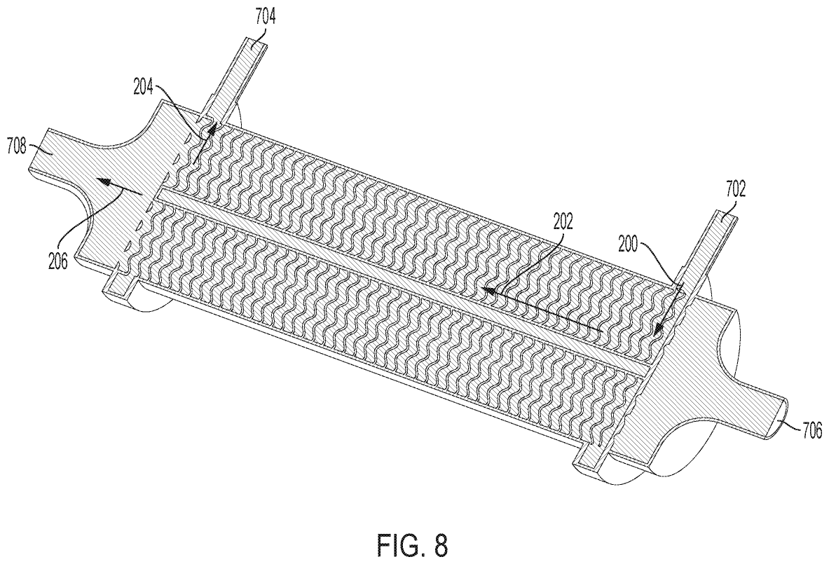

FIG. 8 is a front cross-sectional view of the cylindrical heat exchange cracking unit 700 that utilizes a TPMS structure which depicts the flow of heated exhaust gas and gaseous ammonia through the matrix. In operation, gaseous ammonia 200 is supplied to the inlet 702 and flows through the ammonia channels 716, while heated exhaust gas 202 is concurrently supplied to the inlet 706 and flows through the heated gas channels 718. The heated exhaust gas 202 heats the catalyst, resulting in cracking of the ammonia 200 into constituent hydrogen and nitrogen components 204. The resulting hydrogen and nitrogen components 204 exit the heat exchange cracking unit 700 via the outlet 704 and are supplied to the downstream injection system for the engine, while residual exhaust gas 206 exits the heat exchange cracking unit via the outlet 708.

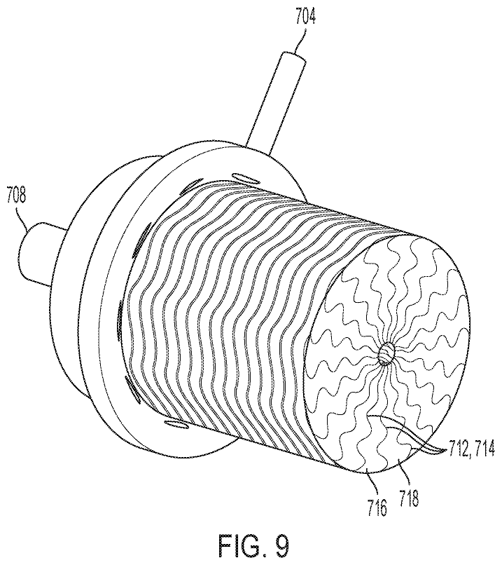

FIG. 9 is a side cross-sectional view of the cylindrical heat exchange cracking unit 700 that utilizes a TPMS structure which depicts the flow of heated exhaust gas and gaseous ammonia through the matrix. As shown in FIG. 9, the surfaces 712, 714 of the matrix 710 creates ammonia channels 716 and heated exhaust gas channels 718. The cylindrical design can provide efficiencies for mass production, given the rounded parts, fewer welded seams/joints compared to square and rectangular designs, and less susceptibility to thermal stress.

It is noted that cylindrical shape of the cylindrical heat exchange cracking unit 700 is an illustrative example only and is not intended to be in any way limiting. In other embodiments, the heat exchange cracking unit 700 can be any polygonal shape, such as, for example, oval, oblong, triangular, square, kite-shaped, trapezoid, parallelogram, rhombus, and the like, as well as various 3D shapes such as, for example, cube, cuboid, sphere, cone, and the like.

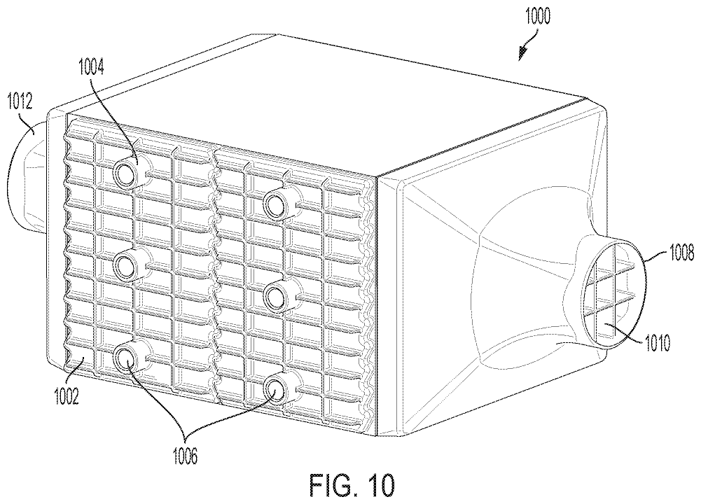

FIG. 10 is a perspective view of a heat exchange cracking unit 1000 that utilizes a tube bundle structure, and which serves as a heat exchanger as well as a catalytic converter that performs ammonia cracking. The heat exchange cracking unit 1000 is metallic, and in an embodiment, includes a sidewall 1002 that includes a gaseous ammonia inlet 1004. In an embodiment, the inlet sidewall 1002 can include additional ports 1006 that may be used for a variety of functions. For example, the ports 1006 may serve an inlets, or may be coupled to equipment for temperature, throughput, and/or pressure sensing.

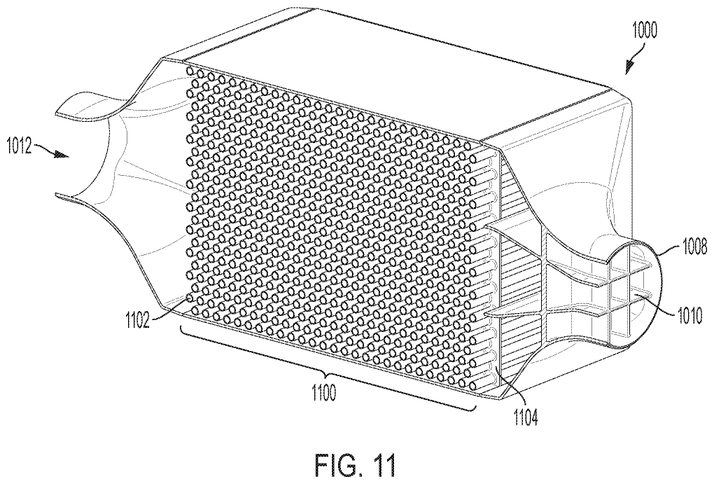

The heat exchange cracking unit 1000 further includes a heated gas inlet 1008. In an embodiment, the heated exhaust gas inlet 1008 includes a divider 1010 which spreads the heated exhaust gas from the engine evenly over the internal tube bundle structure contained within the heat exchange cracking unit 1000, as described in more detail with reference to FIG. 11. In an embodiment, the divider 1010 can have a grid or lattice structure.

The heat exchange cracking unit 1000 includes an exhaust gas outlet 1012 positioned opposite the heated gas inlet 1008.

FIG. 11 is a front cross-sectional view of the heat exchange cracking unit 1000 that utilizes a tube bundle structure. In an embodiment, a tube bundle structure 1100 is disposed within the heat exchange cracking unit 1000. The tube bundle structure 1100 is comprised of individual tubes 1102 which extend along the width of the heat exchange cracking unit 1000 from the sidewall 1002, perpendicular to the inlet 1008 and outlet 1012.

In an embodiment, the tube bundle structure 1100 includes rows and/or columns of tubes 1102 arranged in an offset fashion so that each adjacent row and/or column includes tubes which are offset from its neighboring tubes. This pattern maximizes the surface area contacted by the heated exhaust gas as the gas traverses the tube bundle structure 1100, thereby maximizing the amount of catalyst heated in order to facilitate the cracking process.

In an embodiment, the heat exchange cracking unit 1000 includes at least one support structure 1104 which facilitates the 3D printing process, and further provide stability against thermal stress during operation of the heat exchange cracking unit 1000.

Gaseous ammonia is supplied to the heat exchange cracking unit 1000 via inlet 1004, while heated exhaust gas concurrently is supplied to the inlet 1008. The gaseous ammonia traverses the lateral spaces between the tubes 1102, while the heated exhaust gas traverses the axial space inside the tubes 1102.

In an embodiment, the spaces between the tubes 1102 are filled with a catalyst in the form of a discrete catalyst media. In another embodiment, the tubes 1102 themselves are hollow and are also filled with the discrete catalyst media.

In yet another embodiment, the external surfaces and/or the internal surfaces of the tubes 1102 are also coated with the catalyst using a washcoating or deposition technique to bind or adhere the catalyst to the surfaces.

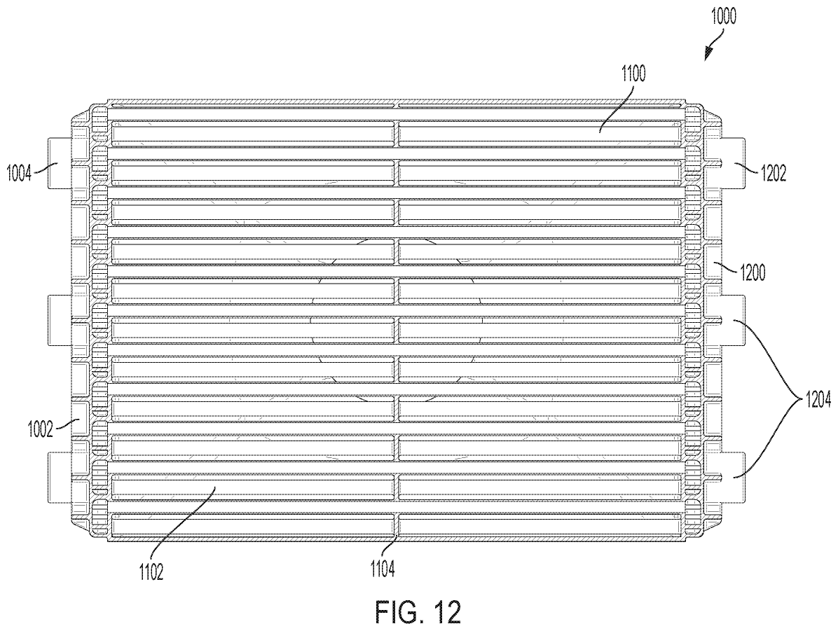

FIG. 12 is a side cross-sectional view of the heat exchange cracking unit 1000 that utilizes a tube bundle structure 1100. In an embodiment, the heat exchange cracking unit 1000 includes a sidewall 1200 positioned opposite the sidewall 1002. The sidewall 1200 includes a hydrogen outlet 1202, and can include additional ports 1204 that may be used for a variety of functions. For example, the ports 1204 may serve as outlets, or may be coupled to equipment for temperature, throughput, and/or pressure sensing.

In operation, gaseous ammonia is supplied to the inlet 1004, while heated exhaust gas is concurrently supplied to the inlet 1008. The heated exhaust gas heats the catalyst, resulting in cracking of the ammonia into constituent hydrogen and nitrogen components. The resulting hydrogen and nitrogen components exit the heat exchange cracking unit 1000 via the outlet 1202 and are supplied to the downstream engine.

In an embodiment, the heat exchange cracking unit 1000 is made from a nickel alloy. In a preferred embodiment, the heat exchange cracking unit 1000 is made from Inconel® 625.

In an embodiment, the sidewalls 1002, 1200, the gaseous ammonia inlet 1004, the hydrogen outlet 1202, the heated exhaust gas inlet 1008, the divider 1010, the exhaust gas outlet 1012, and the support structures 1104 can be made from the same metallic material as the heat exchange cracking unit 1000. In another embodiment, the sidewalls 1002, 1200, the gaseous ammonia inlet 1004, the divider 1010, the hydrogen outlet 1202, the heated exhaust gas inlet 1008, and the exhaust gas outlet 1012 can be made from stainless steel, silver, bronze, and comparable alloys.

In an embodiment, the heat exchange cracking unit 1000 includes a plate heat exchanger. The plate heat exchanger consists of a series of parallel metallic plates that are placed adjacent to one another, thereby forming a series of channels for the respective fluids (i.e., gaseous ammonia and heated exhaust gas) to flow between the plates. The space between two adjacent plates forms a channel in which a respective fluid flows. Heat transfer occurs when the gaseous ammonia flows in one channel, and heated exhaust flows in an adjacent channel, where a common metallic plate separates the two adjacent channels.

Inlet and outlet holes on each of the metallic plates allow the gaseous ammonia and heated exhaust gas to flow through respective adjacent channels, such that a metallic plate is always in contact on one side with gaseous ammonia, and on the other side with heated exhaust gas.

A plate heat exchanger is advantageous as it allows the gaseous ammonia and heated exhaust gas to be spread across multiple plates, thereby exposing the fluids to a large heat transfer surface area.

In an embodiment, the plate heat exchanger utilizes counter-current flow, where the gaseous ammonia flows in one direction in its respective channel, and heated exhaust gas flows in an opposite direction in its respective adjacent channel.

In another embodiment, the plate heat exchanger utilizes parallel flow, where the gaseous ammonia and heated exhaust gas each flow in the same direction in their respective adjacent channels.

In an embodiment, the surfaces of the metallic plates can be corrugated in order to increase the turbulence in the gaseous ammonia and heated exhaust gas as these fluids flow through the plate heat exchanger. This turbulence provides an effective heat transfer coefficient.

In an embodiment, the surfaces of the metallic plates are coated with a catalyst. In another embodiment, the channels where the gaseous ammonia flows are filled with a catalyst, such as discrete catalyst media. In yet another embodiment, the channels where gaseous ammonia flows are filled with a catalyst, and the surfaces of the metallic plates facing these channels where gaseous ammonia flows are also coated with a catalyst.

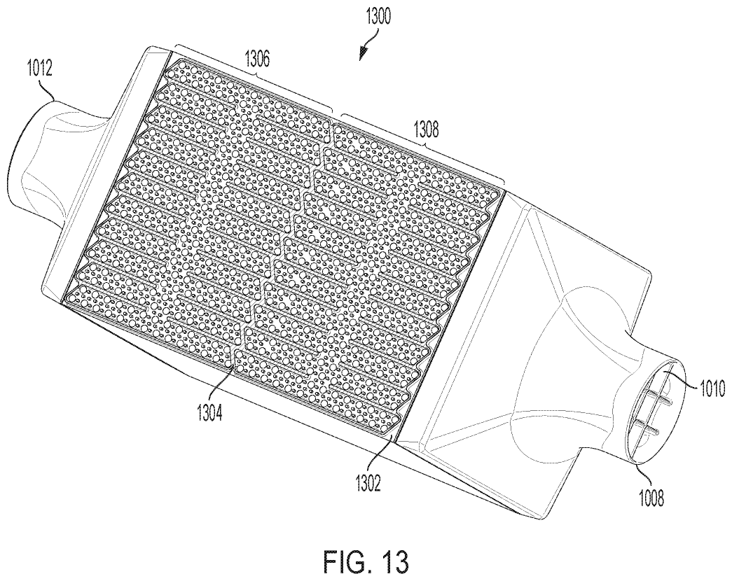

FIG. 13 is a front cross-sectional view of a two-pass heat exchange cracking unit 1300 that utilizes a tube bundle structure 1100. In this embodiment, the support structure 1302 includes a fascia that receives a sidewall (not depicted in FIG. 13). The support structure 1302 includes a divider 1304 which physically separates the tube bundle structure 1100 into a left section 1306 and right section 1308. The divider 1304 extends along the width of the two-pass heat exchange cracking unit 1300 between the two sidewalls. In this embodiment, a gaseous ammonia inlet is positioned on a sidewall covering the left section 1306, and a hydrogen outlet is positioned on a sidewall covering the right section 1308.

In operation, gaseous ammonia is supplied to the gaseous ammonia inlet, while heated exhaust gas is concurrently supplied to the inlet 1008. As the ammonia traverses the left section 1306 of tube bundle structure 1100, heated exhaust gas heats the catalyst, resulting in cracking of the ammonia into constituent hydrogen and nitrogen components. The remaining ammonia traverses back through the right section 1308 of the tube bundle structure 1100 and continues to undergo cracking, thereby providing a two-pass cracking process. The resulting hydrogen and nitrogen components exit the two-pass heat exchange cracking unit 1300 via the hydrogen outlet and are supplied to the downstream engine.

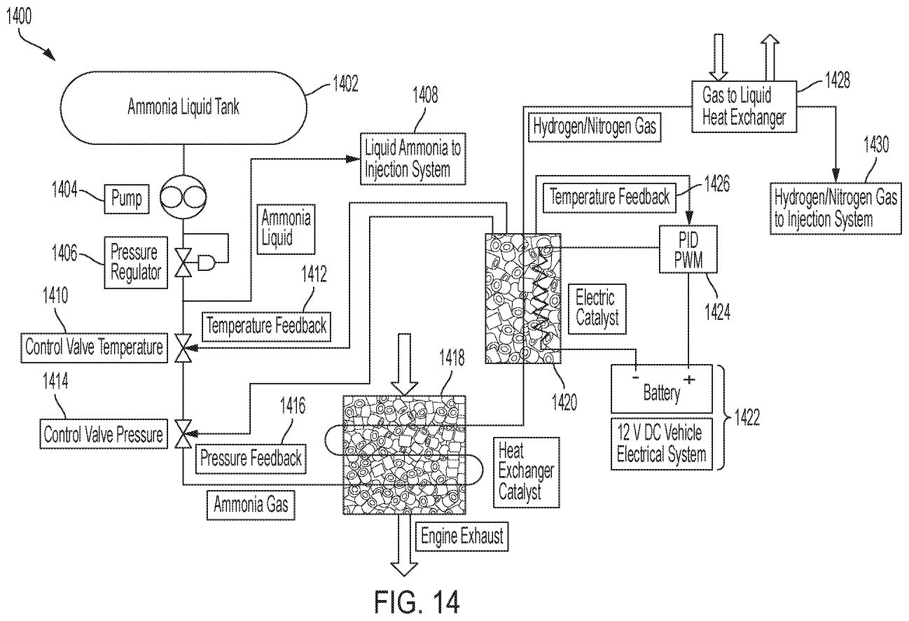

FIG. 14 is a block diagram of an on-board ammonia cracking system for an internal combustion engine. The on-board ammonia cracking system 1400 provides a mechanism to generate hydrogen from ammonia which eliminates the need for a separate hydrogen tank to be carried by the motor vehicle.

Referring FIG. 14, an ammonia liquid tank 1402 is mounted to a motor vehicle or engine, and in an embodiment, the ammonia liquid tank 1402 can be coupled to a pump 1404. In an embodiment, the tank 1402 is refillable and/or replaceable. The pump 1404 can be coupled to a port on the tank 1402 to facilitate the delivery of ammonia from the tank 1402. For example, in a cold environment where the temperature is approximately 0° C. or less, the vapor pressure of ammonia is not adequate to push itself out of the tank 1402. Thus, the pump 1404 is required to draw or force the ammonia out of the tank 1402.

In another embodiment, an electrical heater (not depicted in FIG. 14) can be coupled to the tank 1402, such as within the tank 1402 or on an outer surface of the tank 1402, in order to heat the liquid ammonia contained within the tank 1402 to a temperature where it vaporizes into a gaseous form.

In an embodiment, a pressure regulator 1406 is coupled to an outlet of the tank 1402, and serves to control the volume and/or flow rate of ammonia drawn out of the tank 1402 by the pump 1404. The pressure regulator 1406 monitors the pressure of the liquid ammonia in the tank 1402. Once the pressure lowers to a threshold pressure value whereby the liquid ammonia can vaporize into a gaseous form, the pressure regulator 1406 opens and feeds gaseous ammonia downstream. Any residual liquid ammonia that passes through the pressure regulator 1406 is fed to an injection system 1408 (via, for example, a T-coupling on a supply line).

In an embodiment, a temperature control valve 1410 receives a temperature feedback signal 1412 that contains a temperature reading from an electric cracking unit 1420 during a cold start of the engine. The temperature feedback signal 1412 can be generated by a temperature sensor coupled to the electric cracking unit 1420. Once the electric cracking unit 1420 reaches a threshold temperature (i.e., the temperature reading is equal to or greater than the threshold temperature) suitable to perform the ammonia cracking process, the temperature control valve 1410 opens and the gaseous ammonia passes through the heat exchange cracking unit 1418, and travels downstream to the electric cracking unit 1420, which is heated using power supplied from the vehicle power system 1422.

If the electric cracking unit 1420 has not reached the threshold temperature, then the temperature control valve 1410 continues to monitor the temperature feedback signal 1412, and prevents the downstream travel of the gaseous ammonia. The cold start operation is described in more detail herein.

In an embodiment, the temperature of the heated exhaust gas entering the heat exchange cracking unit 1418 is judged based on the current draw in the electric cracking unit 1420, where the current draw is indicative of how effective the heat exchange cracking unit 1418 is in cracking the gaseous ammonia.

For example, if there is hydrogen and nitrogen passing from the heat exchange cracking unit 1418 to the electric cracking unit 1420, the electric cracking unit 1420 will not perform the ammonia cracking process, and thus will draw minimal or no current.

If, however, gaseous ammonia passes from the heat exchange cracking unit 1418 to electric cracking unit 1420, the ammonia cracking process will occur, drawing current in order to heat the heating element disposed within the electric cracking unit 1420.

However, during a normal or high load operating conditions of the engine (i.e., not during a cold start or low load operating conditions), the on-board ammonia cracking system 1400 does not utilize the electric cracking unit 1420 to perform the ammonia cracking process, and the heat exchange cracking unit 1418 performs the ammonia cracking process as it will have been heated to the threshold temperature by the heated exhaust gas from the engine.

The heat exchange cracking unit 1418 referred to in FIG. 14 can be any of the embodiments described herein: the heat exchange cracking unit 100 that utilizes a TPMS structure, the cylindrical heat exchange cracking unit 700 that utilizes a TPMS structure, the heat exchange cracking unit 1000 that utilizes a tube bundle structure, or the two-pass heat exchange cracking unit 1300 that utilizes a tube bundle structure.

The pressure control valve 1414 is located in series with the temperature control valve 1410, and controls the amount of gaseous ammonia which is fed into the heat exchange cracking unit 1418.

In an embodiment, the pressure control valve 1414 receives a pressure feedback signal 1416 from the heat exchange cracking unit 1418. For example, the heat exchange cracking unit 1418 can be coupled to a pressure transducer or the like (not depicted in FIG. 14) that generates the pressure feedback signal 1416.

In an embodiment, to facilitate a cold start of the on-board ammonia cracking system 1400 when the exhaust gas from the engine is not at a threshold temperature suitable to perform the ammonia cracking process, the electric cracking unit 1420 is used to heat the catalyst so that the gaseous ammonia can be cracked, and the resulting hydrogen is to be supplied to the downstream injection system for the engine. The engine can then burn the hydrogen, powering the engine which results in heated exhaust gas being supplied to the on-board ammonia cracking system 1400.

In an embodiment, the electric cracking unit 1420 is coupled to the vehicle power system 1422, such as a traditional vehicle battery. In another embodiment, the electric cracking unit 1420 can be heated via a supplemental heating/electric source, such as a renewable energy source, a portable battery source, an on-board electric battery pack, and/or a rechargeable battery.

In addition to facilitating a cold start of the on-board ammonia cracking system 1400, the electric cracking unit 1420 is utilized to supplement the heat exchange cracking unit 1418 during low load operating conditions of the engine, such as when the vehicle is stopped, moving slowly, or idling. For example, during low load operating conditions, the engine exhaust gas temperature can drop significantly. The reduced temperature of the exhaust gas flowing into the heat exchange cracking unit 1418 during such low load operating conditions may not be sufficient for the catalyst to crack the ammonia. In an embodiment, depending on the specific catalyst that is utilized, the temperature of the exhaust gas needs to be at least 400° C. to 700° C. in order to perform the ammonia cracking process, and in a preferred embodiment, the temperature of the exhaust gas is at least 600° C. in order to perform the ammonia cracking process.

In this scenario, the cold gaseous ammonia will pass through the heat exchange cracking unit 1418, and will be supplied downstream to the electric cracking unit 1420, which is heated using power supplied from the vehicle power system 1422. Once the electric cracking unit 1420 is heated to a threshold temperature suitable to perform the ammonia cracking process, the temperature control valve 1410 opens and allows the gaseous ammonia to be fed to the heat exchange cracking unit 1418 and ultimately to the electric cracking unit 1420. The electric cracking unit 1420 then performs the ammonia cracking process, and the resulting hydrogen is supplied to the downstream injection system for the engine.

When the exhaust gas flowing into the heat exchange cracking unit 1418 reaches a threshold temperature suitable to perform the ammonia cracking process, such as during normal or high load operating conditions of the engine, the ammonia cracking process occurs within the heat exchange cracking unit 1418. The resulting hydrogen and nitrogen will pass downstream through the electric cracking unit 1420, and further downstream to a gas-to-liquid or gas-to-gas heat exchange unit 1428, and subsequently to the injection system 1430 for the engine. In an embodiment, the gas-to-liquid or gas-to-gas heat exchange unit 1428 may leverage engine coolant and/or the engine radiator, or input ammonia gas or liquid, to facilitate the heat exchange process.

In an embodiment, the pressure regulator 1406 can be controlled with an electric servomotor to provide a steady flow of gaseous ammonia from the tank 1402. In another embodiment, a pulse-width modulated injection valve can be used. The servomotor and/or pulse generators can be controlled using an electronic controller, such as an industrial PID controller (not depicted in FIG. 14).

In an embodiment, the electronic controller can be coupled to various components of the on-board ammonia cracking system 1400 to receive inputs from the pressure regulator 1406, the temperature control valve 1410, pressure control valve 1414, as well as from sensors such as temperature sensors and pressure transducers which may be coupled to the heat-exchange cracking unit 1418 and/or electric cracking unit 1420.

In another embodiment, the electronic controller can be integrated into the hardware and software with the vehicle's electronic control unit (ECU). In this embodiment, the flow rate of hydrogen fed to the injection system of the engine can be measured and reported back to the ECU as a mechanism to control the injection strategy.

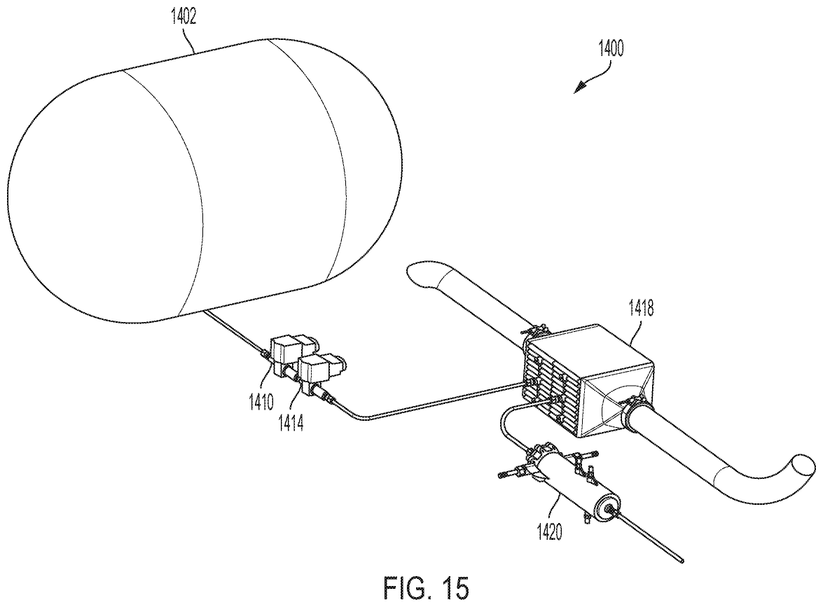

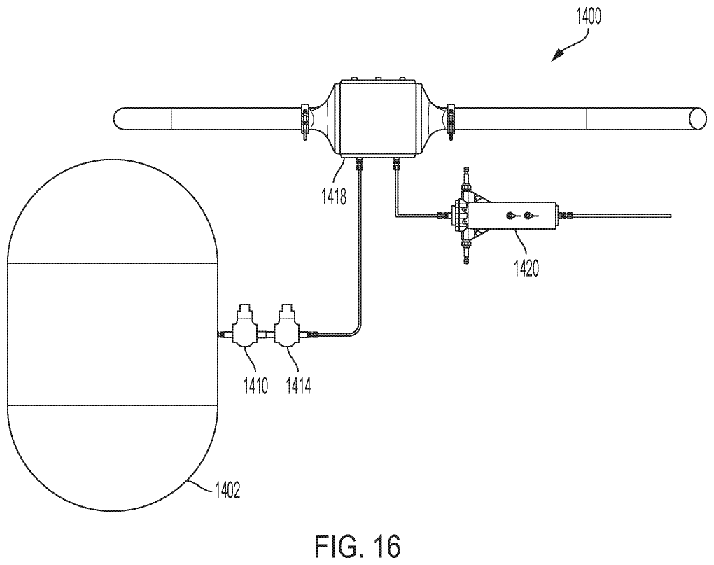

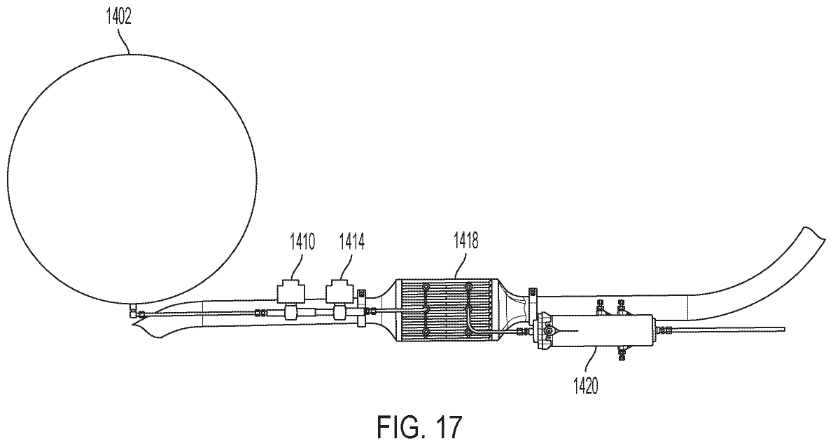

FIGS. 15-17 are various perspective views of the on-board ammonia cracking system 1400 for an internal combustion engine described in FIG. 14.

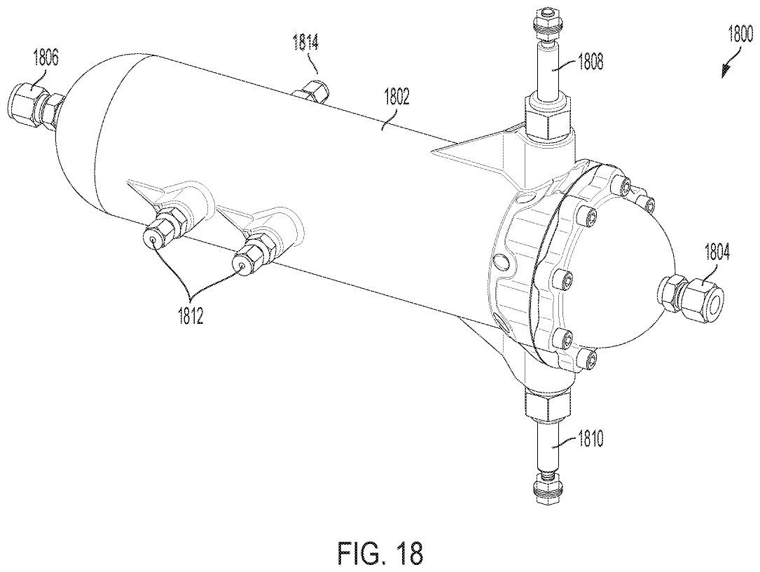

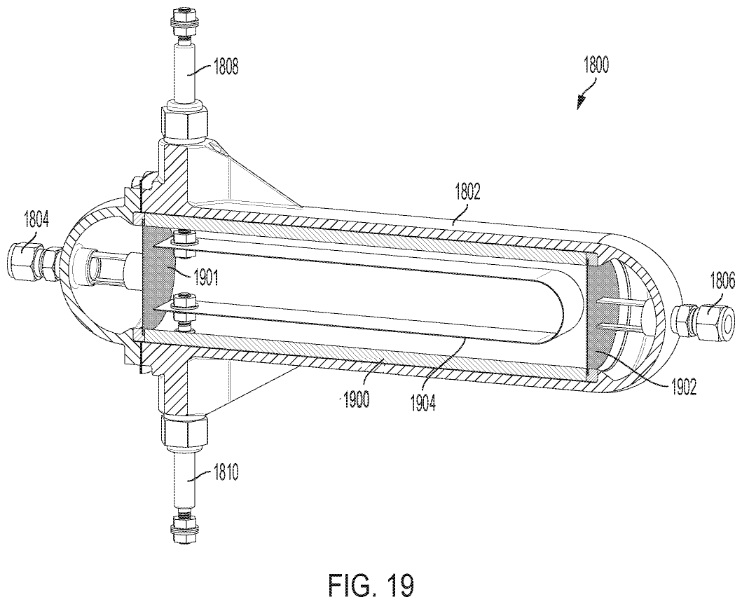

FIG. 18 is a perspective view of an electric cracking unit. In an embodiment, the electric cracking unit 1800 comprises a housing 1802 which encloses a ceramic tube 1900 (depicted in FIG. 19). In an embodiment, the housing 1802 is a metal housing.

In an embodiment, the electric cracking unit 1800 includes a gaseous ammonia inlet 1804 and a hydrogen outlet 1806 disposed on the opposite end of the electric cracking unit 1800. The electric cracking unit further includes power feed-throughs 1808, 1810 for the heating element 1904 (depicted in FIG. 19). In an embodiment, the electric cracking unit 1800 can include radial fittings 1812, 1814 that may be used for a variety of functions. For example, the radial fittings 1812, 1814 may serve an inlets, outlets, or may be coupled to equipment for temperature, throughput, and/or pressure sensing. In an embodiment, the radial fittings 1812 can each include, or be coupled to, thermocouples, and the radial fitting 1814 can include, or be coupled to, a pressure transducer.

FIG. 19 is a cross-sectional view of the electric cracking unit 1800. In an embodiment, a ceramic tube 1900 houses a catalyst. The ceramic tube 1900 acts as an insulator, and allows heat to be focused and reflected toward the catalyst, thereby heating the catalyst.

In an embodiment, a first screen 1901 and second screen 1902 are disposed at opposite ends within the ceramic tube 1900. The screens 1901, 1902 can be made from wire, a wire mesh, or another metallic mesh or matrix structure. In an embodiment, the screens 1901, 1902 can be made from a nickel alloy that is resistant to heated hydrogen gas that is generated from the cracking of ammonia, as well as resistant to the gaseous ammonia itself.

In an embodiment, a heating element 1904 is also disposed within the ceramic tube 1900. Electrical current is passed through the heating element 1904 in order to heat the heating element 1904 to a threshold temperature suitable to perform the ammonia cracking process. In an embodiment, the heating element 1904 and screens 1901, 1902 are made from a nickel alloy, or other material(s) resistant to hydrogen and ammonia, as nickel maintains a fairly constant resistance with high temperatures, as opposed to steel which has a lower resistance at high temperatures. Further, nickel alloys may have a higher resistance to corrosion during exposure to ammonia and hydrogen at high temperatures (which may be realized within the electrical cracking unit 1800, such as, for example, temperatures in excess of 600° C.).

In a preferred embodiment, the heating element 1904 and the screens 1901, 1902 are made from Inconel® 625. In an embodiment, the heating element 1904 and the screens 1901, 1902 can be made from the same material. Alternatively, the heating element 1904 and the screens 1901, 1902 can be made from different materials.

In an embodiment, the heating element 1904 can be an air process heater, a cartridge heater, a tubular heater, a band heater, a strip heater, an etched foil heater (or a thin-film heater), a ceramic heater, a ceramic fiber heater, a resistance wire, and the like.

In an embodiment, respective ends of the heating element 1904 are in contact with the power feed-throughs 1808, 1810. The power feed-throughs 1808, 1810 provide electricity for energizing or heating the heating element 1904.

In an embodiment, the heating element 1904 is regulated via an electronic controller coupled to the power feed-throughs 1808, 1810 by utilizing readings from the thermocouples coupled to the radial fittings 1812, so that the heating element 1904 maintains a threshold temperature suitable to perform the ammonia cracking process. The threshold temperature can range from 400° C. to 700° C., and in a preferred embodiment, the threshold temperature is at least 600° C.

In an embodiment, the electronic controller can be used to control an electric expansion valve (not depicted in FIG. 19) that is coupled to the inlet 1804 by utilizing readings from the pressure transducer coupled to radial fitting 1814 and/or the thermocouples coupled to radial fittings 1812. Once the gaseous ammonia received by the electric cracking unit 1800 from the heat exchange cracking unit has reached the threshold temperature, the electric expansion valve is utilized to maintain the vapor pressure of the gaseous ammonia. At these threshold temperature and pressure values, the electric expansion valve is opened, allowing the ammonia to enter the ceramic tube 1900.

In an embodiment, catalyst, such as discrete catalyst media, is deposited into the ceramic tube. The gaseous ammonia undergoes a chemical reaction with the catalyst disposed within the ceramic tube 1900, and the resulting hydrogen and nitrogen components exit the electric cracking unit 1800 via the outlet 1806 and are supplied to the downstream injection system for the engine.

In another embodiment, the heating element 1904 is coated with a catalyst that facilitates the ammonia cracking process, and discrete catalyst is not disposed within the ceramic tube 1900. In this embodiment, the catalyst is coated to the heating element 1904 using a washcoating or deposition technique to bind or adhere the catalyst to the surfaces of the heating element 1904.

In one embodiment, the heating element 1904 is a strip heater. The heating element 1904 can be coated on all surfaces with the catalyst, or alternatively, a catalyst sleeve can be placed over the strip heating element 1904. In an embodiment, the strip heating element 1904 can have a relatively low heat transfer efficiency so as to maintain a high skin (or boundary layer) temperature of the catalyst that externally coats the strip heating element 1904.

In another embodiment, the heating element 1904 is a spiral heater, a coil heater, or an air process heater, where the internal walls (which contain integral heating elements) are coated with the catalyst.

In yet another embodiment, the catalyst is coated on the interior wall(s) of the ceramic tube 1900. In this embodiment, the catalyst is coated to the interior wall(s) of the ceramic tube 1900 using a washcoating or deposition technique to bind or adhere the catalyst to the wall surfaces.

The remaining figures have been provided to show additional details and embodiments of the on-board ammonia cracking system.

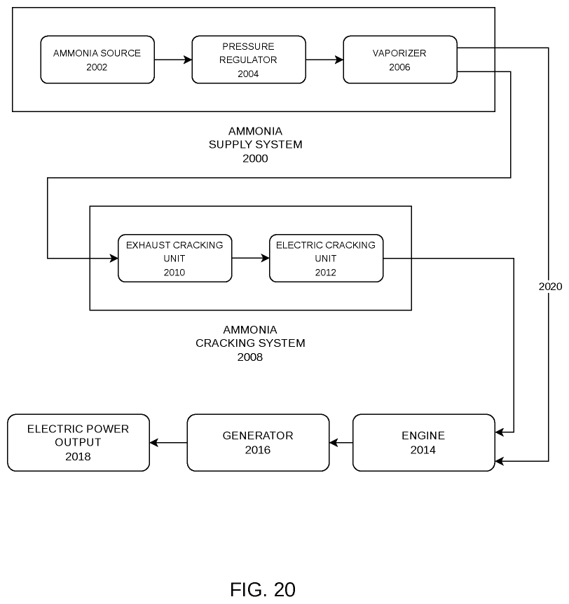

FIG. 20 is a block diagram of a stationary power generation system configured to utilize ammonia cracking to supply fuel to an internal combustion engine-generator set. In an embodiment, the stationary power generation system includes an ammonia supply system 2000 having an ammonia source 2002, a pressure regulator 2004, and a vaporizer 2006.

The ammonia source 2002 may comprise any suitable source of ammonia, including, but not limited to, a local storage vessel, a bulk storage vessel, a remote storage vessel, a centralized storage system, a pipeline, a plant header, a terminal supply system, or another local or external ammonia source configured to deliver ammonia to the ammonia supply system 2000. In an embodiment, ammonia received from the ammonia source 2002 is supplied to the pressure regulator 2004, which regulates the pressure of the ammonia stream before the ammonia is delivered to the vaporizer 2006.

In an embodiment, the vaporizer 2006 is configured to convert ammonia into a gaseous, vaporized ammonia stream suitable for downstream cracking. The gaseous ammonia is then supplied to an ammonia cracking system 2008. In an embodiment, the ammonia cracking system 2008 includes an exhaust cracking unit 2010 and an electric cracking unit 2012 arranged in series. This serial arrangement corresponds to the arrangement shown and described in connection with FIGS. 14 and 15, in which the heat exchange cracking unit 1418 (i.e., the exhaust cracking unit) and the electric cracking unit 1420 are disposed in series within the on-board ammonia cracking system 1400.

In this embodiment, gaseous ammonia first flows through the exhaust cracking unit 2010, where at least a portion of the ammonia may be preheated and/or cracked using exhaust heat, and then flows downstream to the electric cracking unit 2012, where additional cracking may occur using electrically supplied heat.

In an embodiment, the exhaust cracking unit 2010 is configured to utilize heat from engine exhaust to crack ammonia into a hydrogen-containing gas stream. The electric cracking unit 2012 is configured to crack ammonia by using electric power to heat a catalyst and/or heating element, and may be used during startup, low-load operation, transient operation, or other operating conditions in which exhaust heat is insufficient to support cracking in the exhaust cracking unit 2010 alone. Thus, similar to the arrangement and systems described with respect to the heat exchange cracking unit 1418 and electric cracking unit 1420, the ammonia cracking system 2008 can operate such that ammonia or partially cracked gas flows from the exhaust cracking unit 2010 downstream to the electric cracking unit 2012, while under higher exhaust-temperature conditions the exhaust cracking unit 2010 performs the primary cracking function and the resulting hydrogen-containing gas continues downstream through the electric cracking unit 2012.

In an embodiment, hydrogen resulting from ammonia cracking in the ammonia cracking system 2008 is supplied to an internal combustion engine 2014 for use as a co-fuel with gaseous ammonia. The ammonia cracking system 2008 produces a hydrogen-containing gas comprising hydrogen and nitrogen components, and residual ammonia, which is supplied to the engine 2014 together with gaseous ammonia delivered via the supply line 2020. In an embodiment, the engine 2014 is configured to operate on ammonia and hydrogen-containing cracking gas as co-fuels.

In an embodiment, the engine 2014 drives a generator 2016, which converts mechanical output from the engine 2014 into electrical power. The resulting electrical power is provided as electrical power output 2018, which may be supplied to a site load, a building, a facility, a grid, a microgrid, switchgear, a distribution panel, or another electrical distribution system.

In an embodiment, the stationary power generation system of FIG. 20 is configured for standby power, backup power, prime power, continuous-duty power, peak shaving, microgrid operation, or other stationary power applications. In a preferred embodiment, the ammonia supply system 2000, the ammonia cracking system 2008, the engine 2014, and the generator 2016 cooperate so that ammonia can be converted on-site into a hydrogen-containing gas stream and used to generate electrical power output 2018 without requiring a separate primary hydrogen storage system. The arrangement shown in FIG. 20 is illustrative only and is not intended to be limiting.

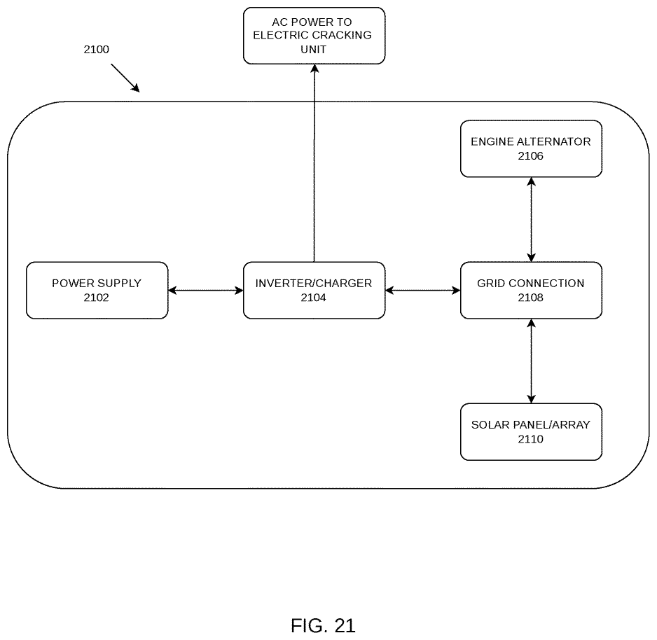

FIG. 21 is a block diagram of a power system for an electric cracking unit for the stationary power generation system. In an embodiment, the power system 2100 for the electric cracking unit 2012 includes a power supply 2102, an inverter/charger 2104, an engine alternator 2106, an optional power grid connection 2108, and an optional solar panel/array 2110.

In an embodiment, the inverter/charger 2104 is electrically coupled with the power supply 2102, the engine alternator 2106, the power grid connection 2108, and the solar panel/array 2110, and is configured to provide AC power to the electric cracking unit 2012.

In an embodiment, the power supply 2102 may comprise a dedicated electrical storage device or group of storage devices configured to provide electrical power for operation of the electric cracking unit 2012. For example, the power supply 2102 may comprise one or more batteries, a battery pack, multiple battery modules, capacitors, supercapacitors, or other electrical energy storage devices. In a preferred embodiment, the power supply 2102 stores electrical energy so that the electric cracking unit 2012 may be operated during startup, black-start operation, low-load operation, or other conditions in which electric cracking assistance is required.

In an embodiment, the inverter/charger 2104 is configured to receive electrical power from one or more of the power supply 2102, the engine alternator 2106, the power grid connection 2108, and the solar panel/array 2110, and to condition, convert, route, and/or charge electrical power as needed for operation of the electric cracking unit 2012. In one embodiment, the inverter/charger 2104 converts electrical power from the power supply 2102 into AC power suitable for energizing the electric cracking unit. In another embodiment, the inverter/charger 2104 receives electrical power from the engine alternator 2106, the power grid connection 2108, and/or the solar panel/array 2110 and uses such power to charge the power supply 2102, power the electric cracking unit directly 2012, or perform both functions.

In an embodiment, the engine alternator 2106 is mechanically driven by the engine 2014 and is configured to provide electrical power during engine operation. In a preferred embodiment, electrical power from the engine alternator 2106 is supplied to the inverter/charger 2104, which then charges the power supply 2102 and/or provides power to the electric cracking unit 2012. In this embodiment, the engine alternator 2106 can replenish the power supply 2102 after engine startup and maintain the power supply 2102 at full charge or near full charge during operation of the engine 2014.

In an embodiment, the power grid connection 2108 permits the power system 2100 to receive utility power from an external electrical grid. In one embodiment, grid power supplied through the power grid connection 2108 may be used to energize the electric cracking unit 2012 through the inverter/charger 2104. In another embodiment, grid power may be used to charge the power supply 2102 through the inverter/charger 2104. In a further embodiment, the availability of the power grid connection 2108 may enable the electric cracking unit 2012 to be energized before startup of the engine 2014 so that ammonia cracking can begin prior to the availability of exhaust heat.

In an embodiment, the solar panel/array 2110 is configured to supply electrical power derived from solar energy to the inverter/charger 2104. In one embodiment, the solar panel/array 2110 may provide supplemental power for operation of the electric cracking unit 2012. In another embodiment, the solar panel/array 2110 may charge the power supply 2102 through the inverter/charger 2104. In a preferred embodiment, the solar panel/array 2110 is used to charge the power supply 2102 during daylight hours, thereby improving system readiness for startup and black-start operation.

In an embodiment, the power system 2100 is configured so that the electric cracking unit 2012 can be powered from the power supply 2102 alone, from the engine alternator 2106, from the power grid connection 2108, from the solar panel/array 2110, or from any combination thereof. In this manner, the power system 2100 provides operational flexibility for startup, standby, low-load operation, off-grid operation, black-start operation, and normal steady-state operation of the ammonia cracking system. The arrangement shown in FIG. 21 is illustrative only and is not intended to be limiting.

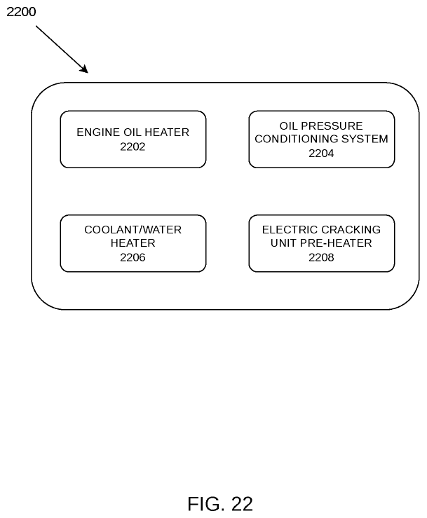

FIG. 22 is a block diagram of a fast start system for the stationary power generation system. In an embodiment, the fast start system 2200 includes an engine oil heater 2202, an oil pressure conditioning system 2204, a coolant/water heater 2206, and an electric cracking unit pre-heater 2208. The fast start system 2200 is configured to condition one or more engine and ammonia-cracking subsystems prior to and/or during startup so that the engine 2014 and the electric cracking unit 2012 can be brought to an operating condition more quickly, thereby reducing startup delay in standby, backup, black-start, and other on-demand operating conditions.

In an embodiment, the engine oil heater 2202 is configured to heat engine oil prior to startup of the engine 2014. By heating the engine oil, the engine oil heater 2202 can reduce oil viscosity at low ambient temperatures, improve oil circulation during startup, and reduce the time required for the engine to reach acceptable lubrication conditions. In one embodiment, the engine oil heater 2202 may comprise an immersion heater, an in-line heater, a pad heater, a reservoir heater, or another heating device configured to raise the temperature of engine oil before engine crank and/or during startup.

In a further embodiment, a circulation pump may be used in conjunction with the engine oil heater 2202 and/or the oil pressure conditioning system 2204 to circulate heated oil through at least a portion of the engine lubrication system so that oil temperature can be maintained during standby operation and available more quickly at startup.

In an embodiment, the oil pressure conditioning system 2204 is configured to establish, build, maintain, and/or precondition oil pressure within the engine lubrication system before ignition or during engine startup. In one embodiment, the oil pressure conditioning system 2204 may include a pre-lube pump, an auxiliary oil pump, a pressurized oil reservoir, one or more valves, an accumulator, one or more sensors, and/or associated control hardware configured to circulate lubricating oil through at least a portion of the engine 2014 prior to engine crank. In this manner, the oil pressure conditioning system 2204 may reduce dry-start conditions, improve lubrication of engine components, and facilitate rapid startup. In a further embodiment, the circulation pump associated with the oil pressure conditioning system 2204 may also be used to maintain oil temperature during standby operation by circulating heated oil through the engine 2014.

In an embodiment, the coolant/water heater 2206 is configured to heat coolant, water, and/or another heat transfer fluid, such as liquid ammonia, associated with the engine 2014 or an associated thermal management system. In one embodiment, the coolant/water heater 2206 may raise the temperature of the engine block, cylinder head, coolant jacket, heat exchanger, or another thermally coupled component so that combustion stability and startup responsiveness are improved. In another embodiment, the coolant/water heater 2206 may maintain the engine 2014, the electric cracking unit 2012, and associated fluids above a threshold temperature during standby operation so that the stationary power generation system can be brought online rapidly when electrical power is demanded.

In a further embodiment, liquid ammonia from the ammonia source 2002 may be used as a heat transfer fluid, either alone or in combination with coolant, water, or another heat transfer fluid, to transfer heat within the stationary power generation system. In a further embodiment, a circulation pump may be used with the coolant/water heater 2206 to circulate heated coolant, water, ammonia, or another heat transfer fluid through the engine 2014, the electric cracking unit 2012, and/or associated thermal pathways so that fluid temperature is maintained during standby operation and rapid startup is facilitated.

In an embodiment, the electric cracking unit pre-heater 2208 is configured to maintain the electric cracking unit 2012 in a warmed or pre-heated condition prior to startup so that the electric cracking unit 2012 can begin ammonia cracking more quickly when a startup command is received. In one embodiment, the electric cracking unit pre-heater 2208 may comprise an electrical heater, a jacket heater, a contact heater, a band heater, a cartridge heater, a heating blanket, or another heating arrangement thermally coupled to the electric cracking unit 2012. By maintaining the electric cracking unit 2012 above ambient temperature, the electric cracking unit pre-heater 2208 can reduce the time required for the electric cracking unit 2012 to reach a threshold temperature suitable for ammonia cracking and thereby enable a faster system start. This is consistent with the broader system architecture in which the electric cracking unit 2012 is used during startup before sufficient exhaust heat is available for the exhaust cracking unit 2010.

In an embodiment, the fast start system 2200 may operate such that one or more of the engine oil heater 2202, the oil pressure conditioning system 2204, the coolant/water heater 2206, the electric cracking unit pre-heater 2208, and one or more associated circulation pumps are energized prior to receipt of a startup command, in response to a startup command, according to a schedule, according to ambient conditions, or according to a readiness mode of the stationary power generation system. In another embodiment, the fast start system 2200 may be controlled by a control system, such as a PLC, controller, or supervisory control system, which selectively activates one or more of the components of the fast start system 2200 based on sensed temperature, pressure, time, load demand, engine status, battery state of charge, grid availability, or other operating parameters.

In an embodiment in which the stationary power generation system is used as a backup power system such that the primary power to the site is supplied by the grid, one or more components of the fast start system 2200, including the one or more circulation pumps, the electric cracking unit pre-heater 2208, the engine oil heater 2202, the oil pressure conditioning system 2204, and/or the coolant/water heater 2206, may be powered using the grid through the power grid connection 2108 prior to startup of the engine 2014. In this manner, the engine 2014 and the electric cracking unit 2012 can be maintained in a ready condition while utility power is available. Once the stationary power generation system is running and the engine 2014 is producing power, the fast start components may be disengaged, de-energized, reduced in power, or otherwise no longer actively operated because the engine 2014 and associated subsystems no longer require the startup conditioning provided by the fast start system 2200.

In an embodiment, the fast start system 2200 is used in conjunction with the ammonia cracking system 2008, the engine 2014, and the generator 2016 so that the stationary power generation system can achieve rapid startup, reduced delay in load acceptance, improved cold-weather operation, improved electric cracking readiness, and improved system readiness for critical-load applications. The arrangement shown in FIG. 22 is illustrative only and is not intended to be limiting.

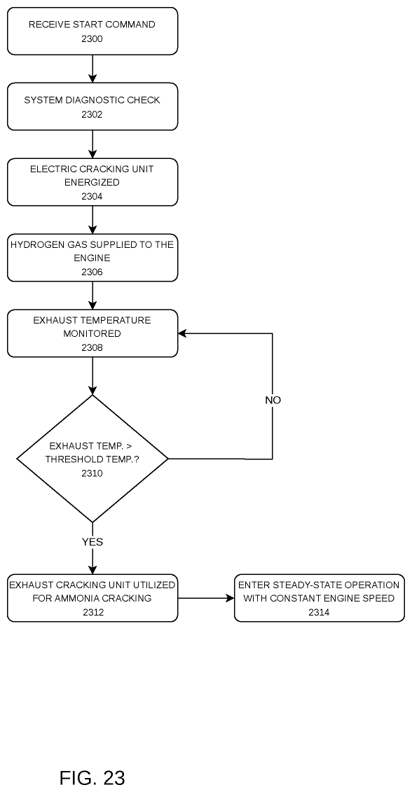

FIG. 23 is a flow chart illustrating a normal startup sequence for the stationary power generation system. In an embodiment, the startup process begins at step 2300, where a start command is received. The start command may be generated manually, automatically, remotely, in response to a loss of grid power, in response to a site-load demand, or in response to another operating condition calling for startup of the stationary power generation system.

At step 2302, a system diagnostic check is performed by the control system. In an embodiment, the control system receives signals from one or more sensors, transducers, switches, gauges, and monitoring devices and evaluates whether startup conditions are satisfied. The system diagnostic check may include one or more safety checks and readiness checks for pressures, levels, leaks, temperatures, valve states, sensor status, electrical readiness, and/or other operating parameters of the stationary power generation system. For example, the diagnostic check may include checking ammonia pressure, fuel availability, coolant level, oil level, leak detection sensors, temperature sensors, and related subsystems to verify that startup may proceed safely.

If the system diagnostic check is satisfactory, the process advances to step 2304, where the electric cracking unit 2012 is energized to crack ammonia into a hydrogen-containing gas stream during startup. The process then advances to step 2306, where the hydrogen-containing gas is supplied to the engine. In an embodiment, the hydrogen supplied at step 2306 is produced by the electric cracking unit 2012 from ammonia received from the ammonia supply system and is used to facilitate engine startup and early engine operation until sufficient exhaust heat is available for the exhaust cracking unit 2010 to perform ammonia cracking.

At step 2308, exhaust temperature is monitored to determine whether the exhaust cracking unit 2010 has reached a threshold temperature suitable to support ammonia cracking using exhaust heat. At step 2310, the system determines whether the exhaust temperature is greater than the threshold temperature. If the exhaust temperature is not greater than the threshold temperature, the startup process continues with the electric cracking unit 2012 providing cracking assistance while hydrogen gas continues to be supplied to the engine 2014 and exhaust temperature continues to be monitored. As described herein with respect to the on-board ammonia cracking system, the threshold temperature can range from 400° C. to 700° C., and in a preferred embodiment, the threshold temperature is at least 600° C.

If the exhaust temperature is greater than the threshold temperature, the process advances to step 2312, where the exhaust cracking unit 2010 is utilized for ammonia cracking. In an embodiment, once the system transitions to using the exhaust cracking unit 2010 for ammonia cracking at step 2312, the process advances to step 2314, in which the stationary power generation system enters a steady-state operating mode with constant engine speed. In this steady-state operating mode, the engine 2014 is maintained at a substantially constant operating speed, such as a substantially constant RPM, by a governor, speed controller, engine control system, or another similar mechanism configured to regulate engine speed. As site electrical demand changes, fuel and air supplied to the engine may be increased or decreased while the governor or similar mechanism maintains the engine 2014 at substantially the same operating speed. In this manner, the normal startup sequence transitions from electrically assisted ammonia cracking to exhaust-based ammonia cracking and then to steady-state power generation.

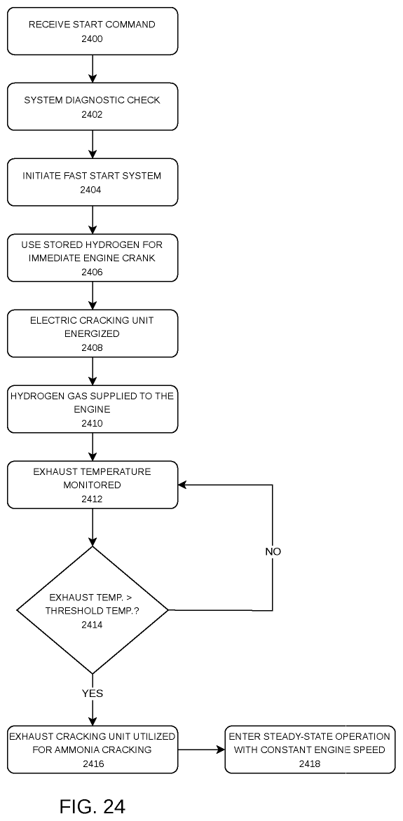

FIG. 24 is a flow chart illustrating a fast startup sequence for the stationary power generation system. In an embodiment, the flow of FIG. 24 is substantially identical to the normal startup sequence shown in FIG. 23, except that the fast startup sequence further includes step 2404, in which the fast start system 2200 of FIG. 22 is initiated, and step 2406, in which stored hydrogen is utilized for immediate engine crank. Thus, except for the additional fast-start steps 2404 and 2406, the remaining steps of FIG. 24 may proceed in the same general manner as described with respect to FIG. 23.

The process begins at step 2400, where a start command is received. At step 2402, a system diagnostic check is performed by the control system. In an embodiment, the system diagnostic check includes one or more safety checks and readiness checks for pressures, levels, leaks, temperatures, valve states, sensor status, electrical readiness, and/or other operating parameters of the stationary power generation system, as described with respect to FIG. 23. If the system diagnostic check is satisfactory, the process advances to step 2404, where the fast start system 2200 is initiated.

In an embodiment, initiation of the fast start system at step 2404 may include energizing one or more of the engine oil heater 2202, the oil pressure conditioning system 2204, the coolant/water heater 2206, and the electric cracking unit pre-heater 2208 so as to condition the engine 2014, the electric cracking unit 2012, and associated subsystems for more rapid startup. The process then advances to step 2406, where stored hydrogen is utilized for immediate engine crank. In an embodiment, the stored hydrogen may be supplied from a hydrogen tank, one or more hydrogen bottles, or another hydrogen storage vessel, and may be used to facilitate immediate crank, ignition, and/or initial combustion before the electric cracking unit 2012 becomes the primary source of hydrogen-containing gas during startup.

After steps 2404 and 2406 are completed, the startup sequence may continue in the same manner as the normal startup sequence of FIG. 23, including energization of the electric cracking unit 2012 at step 2408, supply of hydrogen gas to the engine at step 2410, monitoring of exhaust temperature at step 2412, determination at step 2414 whether exhaust temperature exceeds a threshold temperature, utilization of the exhaust cracking unit 2010 for ammonia cracking at step 2416, and entry into steady-state operation with constant engine speed at step 2418.

In this manner, FIG. 24 may be understood as the normal startup flow of FIG. 23 with the addition of a fast-start conditioning step and a stored-hydrogen-assisted crank step. This arrangement allows the stationary power generation system to achieve more rapid startup while still transitioning to electrically assisted ammonia cracking, exhaust-based ammonia cracking, and steady-state operation in the same general manner described for FIG. 23.

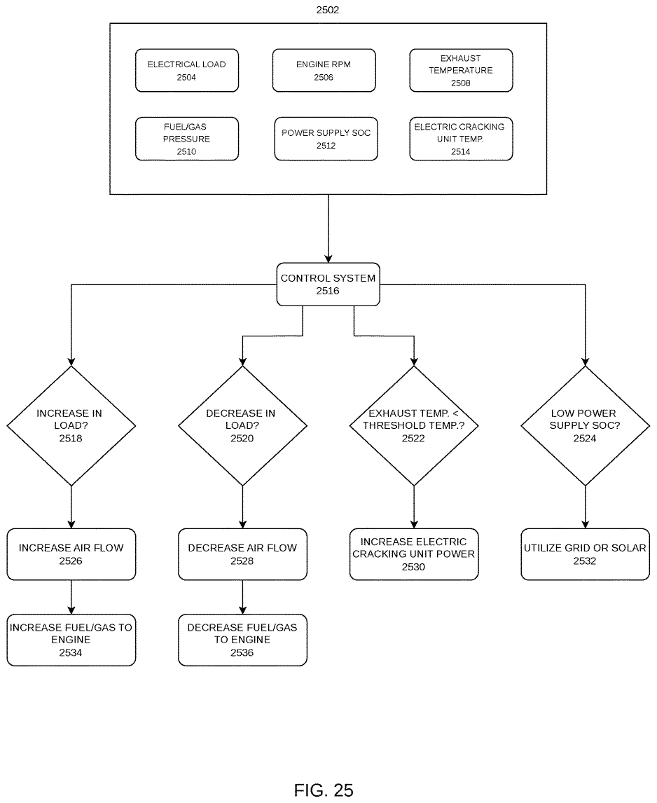

FIG. 25 is a flow chart illustrating a steady-state control sequence for the stationary power generation system during operation. In an embodiment, a control system 2516 receives one or more operating inputs 2502 including electrical load 2504, engine RPM 2506, exhaust temperature 2508, fuel/gas pressure 2510, power supply state of charge (SOC) 2512, and electric cracking unit temperature 2514. The control system 2516 is configured to process these inputs and regulate operation of the stationary power generation system so that the engine 2014, ammonia cracking system 2008, and associated power subsystems continue to operate in a stable manner during steady-state power generation. In an embodiment, the control system 2516 may monitor the input values continuously or periodically and may issue control commands in response to changes in site demand, cracking conditions, electric cracking unit operating temperature, and available electrical support power.

In an embodiment, the control system 2516 determines at step 2518 whether there has been an increase in electrical load. If an increase in load is detected, the control system 2516 may increase air flow at step 2526 and may further increase the fuel/gas supplied to the engine at step 2534 so that generator output can satisfy the increased electrical demand while maintaining desired engine operation.

The control system 2516 may also determine at step 2520 whether there has been a decrease in electrical load. If a decrease in load is detected, the control system 2516 may decrease air flow at step 2528 and may further decrease the fuel/gas supplied to the engine at step 2536 so as to maintain efficient operation during the reduced load condition. In an embodiment, the engine 2014 may be maintained at a substantially constant operating speed, such as a substantially constant RPM, by a governor, speed controller, engine control system, or another similar mechanism while air flow and fuel/gas delivery are adjusted to track load demand.

In an embodiment, the control system 2516 determines at step 2522 whether the exhaust temperature is below a threshold temperature. If the exhaust temperature is below the threshold temperature, the control system 2516 may increase power to the electric cracking unit 2012 at step 2530 so that ammonia cracking can continue despite reduced exhaust-based cracking capability. In this manner, the electric cracking unit 2012 may supplement the exhaust cracking unit 2010 during steady-state operation when exhaust heat is insufficient to satisfy cracking demand. In an embodiment, the electric cracking unit temperature input 2514 may also be used by the control system 2516 to regulate the level of electric cracking unit power applied at step 2530 so that the electric cracking unit 2012 is maintained at a temperature suitable for ammonia cracking.

The control system 2516 may also determine at step 2524 whether the power supply SOC is low. If the power supply SOC is low, the control system 2516 may utilize the grid connection 2108 and/or the solar panel/array 2110 at step 2532 to support the electric cracking unit 2012 and/or recharge the power supply 2102. In another embodiment, if the power supply SOC is low, the control system 2516 may reduce power supplied to the electric cracking unit 2012 and generate an alert, alarm, warning signal, or status notification indicating the low power supply condition.

Thus, the steady-state control sequence of FIG. 25 allows the stationary power generation system to respond to changing electrical load, reduced exhaust temperature, reduced power supply charge, and electric cracking unit temperature conditions while continuing to provide reliable power output.

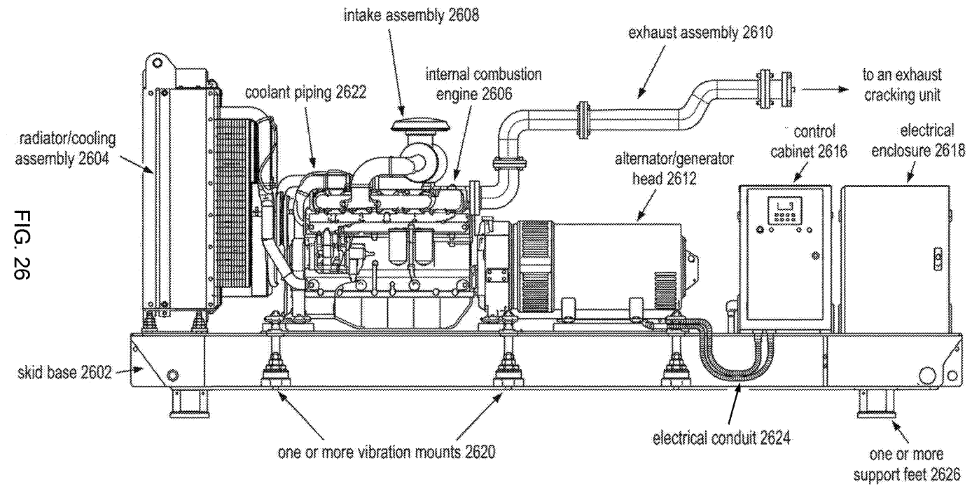

FIG. 26 is a perspective view of a skid-mounted generator system 2600. In an embodiment, the skid-mounted generator system 2600 includes a skid base 2602, a radiator/cooling assembly 2604, an internal combustion engine 2606, an intake assembly 2608, an exhaust assembly 2610, an alternator/generator head 2612, a control cabinet 2616, an electrical enclosure 2618, one or more vibration mounts 2620, coolant piping 2622, electrical conduit 2624, and one or more support feet 2626. The arrangement shown in FIG. 26 is illustrative only and is not intended to be limiting.

In an embodiment, the skid base 2602 provides a structural platform upon which the components of the skid-mounted generator system 2600 are mounted. The skid base 2602 may be formed from steel, aluminum, or another structural material and may be configured to facilitate transport, installation, and stationary deployment of the generator system 2600. In an embodiment, the support feet 2626 extend from or are associated with the skid base 2602 and are configured to support the generator system 2600 on an underlying surface, foundation, pad, deck, or other mounting location.

In an embodiment, the internal combustion engine 2606 is mounted on the skid base 2602 and is configured to provide mechanical power for electrical generation. The internal combustion engine 2606 may be configured to operate on one or more fuels, including ammonia, hydrogen, a hydrogen-containing cracking gas, or co-fuels including ammonia and hydrogen, as described herein. The intake assembly 2608 is operatively associated with the internal combustion engine 2606 and is configured to provide intake air and/or an intake gas stream to the internal combustion engine 2606. The exhaust assembly 2610 is operatively associated with the internal combustion engine 2606 and is configured to direct exhaust gas from the internal combustion engine 2606 to the exhaust cracking unit for use in ammonia cracking during operation.

In an embodiment, the alternator/generator head 2612 is mechanically coupled to the internal combustion engine 2606 such that rotation of the internal combustion engine 2606 drives the alternator/generator head 2612 to produce electrical power. The alternator/generator head 2612 may include a generator housing and associated internal generator components configured to convert mechanical energy from the internal combustion engine 2606 into electrical energy for supply to a load, a building, a facility, a site, a grid, a microgrid, or another electrical distribution system.

In an embodiment, the radiator/cooling assembly 2604 is configured to remove heat from the internal combustion engine 2606 and/or other components of the skid-mounted generator system 2600. The radiator/cooling assembly 2604 may include a heat exchanger, radiator core, fan, shroud, and associated coolant pathways for circulating coolant to and from the internal combustion engine 2606. Coolant piping 2622 may fluidly couple the radiator/cooling assembly 2604 with the internal combustion engine 2606 and/or other cooled components so as to circulate coolant and maintain desired operating temperatures.

In an embodiment, the control cabinet 2616 is configured to house one or more control devices, displays, switches, breakers, relays, controllers, and/or monitoring components associated with operation of the skid-mounted generator system 2600. The control cabinet 2616 may provide local control, monitoring, and protection functions for the generator system 2600, and may be communicatively coupled with a control system, PLC, supervisory controller, or other automation system. In an embodiment, the electrical enclosure 2618 is configured to house electrical connections, terminals, conductors, protective devices, or other electrical components associated with power output and/or electrical interfacing of the skid-mounted generator system 2600.

In an embodiment, electrical conduit 2624 is used to route electrical wiring and/or conductors between components of the skid-mounted generator system 2600, such as between the alternator/generator head 2612, the control cabinet 2616, and the electrical enclosure 2618. The electrical conduit 2624 may provide protection and organization for the electrical wiring and may facilitate reliable electrical interconnection between the components of the generator system 2600.

In an embodiment, the internal combustion engine 2606, alternator/generator head 2612, and/or other components mounted on the skid base 2602 may be supported by one or more vibration mounts 2620. The vibration mounts 2620 may be configured to reduce transmission of vibration from the internal combustion engine 2606 and alternator/generator head 2612 to the skid base 2602, thereby reducing noise, improving stability, and reducing wear on the overall system.

In an embodiment, the skid-mounted generator system 2600 may be used as a stationary generator set for standby power, backup power, prime power, continuous-duty power, microgrid applications, marine applications, industrial power generation, or other stationary and semi-stationary electrical generation applications. The configuration shown in FIG. 26 may also be incorporated into a broader stationary power generation system, including systems utilizing ammonia cracking and hydrogen/ammonia co-fuels, as described elsewhere herein. The particular shape, size, and arrangement of the components shown in FIG. 26 may vary depending on application, power rating, installation requirements, and system architecture.

In an embodiment, the skid-mounted generator system 2600 further includes the ammonia cracking system 2008 integrated with the skid-mounted components so that hydrogen-containing cracking gas can be generated on-site and supplied to the internal combustion engine 2606. In one embodiment, the ammonia cracking system may include an ammonia supply system, an exhaust cracking unit, and an electric cracking unit arranged in series, as described elsewhere herein. Ammonia may be delivered to the ammonia cracking system from a local storage vessel, a remote source, or another ammonia source, and may be conditioned prior to cracking. The exhaust cracking unit may be thermally coupled to the exhaust assembly 2610 and configured to utilize heat from engine exhaust to crack ammonia, while the electric cracking unit may be electrically coupled to the generator system power architecture and configured to provide startup cracking, supplemental cracking, and/or assist cracking when exhaust heat is insufficient. In an embodiment, hydrogen resulting from ammonia cracking is supplied to the internal combustion engine 2606 for use as a co-fuel with ammonia, and the resulting engine output drives the alternator/generator head 2612 to generate electrical power.

In an embodiment, a plurality of stationary power generation systems may be connected in parallel to provide redundancy, scalability, and load sharing. In such an embodiment, two or more stationary generator systems may be electrically coupled to a common bus, switchgear, paralleling panel, microgrid, building distribution system, or other electrical distribution network so that the generator systems operate together to supply electrical power to one or more loads.

The parallel arrangement allows one generator system to operate alone during lower load conditions, while additional generator systems may be brought online as electrical demand increases. In this manner, the total available power output may be scaled by selectively operating one, two, or more generator systems in parallel.

In another embodiment, the parallel configuration provides redundancy by allowing one generator system to continue supplying power if another generator system is shut down, taken offline for maintenance, derated, or experiences a fault. The parallel configuration may also permit N+1 operation, spinning reserve operation, staged dispatch, or selective generator commitment so that reliability is improved while fuel consumption and operating hours may be managed across the available generator systems.

In an embodiment, each stationary generator system may include its own ammonia supply system, ammonia cracking system, engine, generator, and control system, while a supervisory controller coordinates synchronization, breaker control, load sharing, startup order, shutdown order, and fault isolation among the parallel-connected generator systems.

In another embodiment, multiple stationary generator systems may be arranged in a series, staged, or cascading configuration to provide an uninterruptible power supply (UPS) arrangement for critical loads. In such an embodiment, a first stationary generator system may operate as a primary power source, while a second stationary generator system is arranged downstream, in reserve, or in a backup role and is configured to assume the load if the primary generator system is interrupted, shut down, or otherwise unavailable. One or more transfer devices, static transfer switches, UPS controllers, bus ties, or related switching equipment may be used so that power is maintained to the critical load during transition between the multiple stationary generator systems.

In an embodiment, the series configuration may be used in hospitals, data centers, telecommunications facilities, server installations, military facilities, industrial controls, and other applications in which even a brief interruption in electrical service is undesirable. The secondary generator system may be maintained in a hot standby state, warm standby state, synchronized standby state, or other ready condition so that transition from the primary generator system to the secondary generator system occurs with minimal interruption. In another embodiment, three or more stationary generator systems may be arranged in a staged series architecture so that a primary generator system, a secondary generator system, and a tertiary generator system are sequentially available to maintain continuous power in the event of a fault, maintenance event, or overload condition affecting one or more of the other generator systems.

In an embodiment, therefore, multiple stationary generator systems may be arranged in parallel to provide redundancy, scalability, and load sharing, or may be arranged in series to provide staged backup and uninterruptible power delivery for critical loads. In either arrangement, a supervisory control system may coordinate startup, synchronization, transfer logic, breaker operation, load assignment, fault isolation, and shutdown of the multiple stationary generator systems so that continuous and reliable power delivery is maintained.

While the principles of the disclosure have been illustrated in relation to the exemplary embodiments shown herein, the principles of the present invention are not limited thereto and include any modification, variation, or permutation thereof.

1. A stationary power generation system, comprising:
an ammonia supply system including an ammonia source, a pressure regulator, and a vaporizer configured to provide gaseous ammonia;
an ammonia cracking system fluidly coupled to the ammonia supply system, the ammonia cracking system including an exhaust cracking unit and an electric cracking unit arranged in series along a single ammonia flow path such that gaseous ammonia flows through the exhaust cracking unit before flowing to the electric cracking unit;
an internal combustion engine;
a generator mechanically coupled to the internal combustion engine;
an ammonia supply line configured to supply gaseous ammonia from the ammonia supply system directly to the internal combustion engine;
a cracking-gas line configured to supply a hydrogen-containing gas from the ammonia cracking system to the internal combustion engine, wherein the internal combustion engine is configured to operate on the gaseous ammonia and the hydrogen-containing gas as co-fuels; and
a control system configured to:
(i) during startup, energize the electric cracking unit to generate the hydrogen-containing gas before the exhaust cracking unit reaches a threshold temperature suitable for ammonia cracking using exhaust heat; and
(ii) after the exhaust cracking unit reaches the threshold temperature, utilize the exhaust cracking unit for ammonia cracking while maintaining the internal combustion engine at a substantially constant operating speed as electrical load changes.

2. The stationary power generation system of claim 1, wherein the threshold temperature is in a range of about 400° C. to about 700° C.

3. The stationary power generation system of claim 1, further comprising a power system for the electric cracking unit, the power system including a power supply, an inverter/charger, and an engine alternator mechanically driven by the internal combustion engine.

4. The stationary power generation system of claim 3, wherein the power system further includes a grid connection and a solar panel or solar array, and wherein the inverter/charger is configured to selectively power the electric cracking unit from the power supply, the engine alternator, the grid connection, the solar panel or solar array, or any combination thereof.

5. The stationary power generation system of claim 1, further comprising a fast start system including an engine oil heater, an oil pressure conditioning system, a coolant or water heater, and an electric cracking unit pre-heater configured to maintain the electric cracking unit in a warmed condition before startup.

6. The stationary power generation system of claim 5, wherein the fast start system further comprises a stored-hydrogen source configured to provide stored hydrogen for immediate engine crank during a fast startup mode.

7. The stationary power generation system of claim 1, wherein the control system is configured to monitor a power-supply state of charge and an electric cracking unit temperature and, when the power-supply state of charge is below a threshold, to:
(i) utilize grid power or solar power to support the electric cracking unit or recharge the power supply,
(ii) reduce power to the electric cracking unit, or
(iii) generate an alert indicative of a low-power condition.

8. A method of operating a stationary power generation system, comprising:
supplying ammonia from an ammonia source to a pressure regulator and a vaporizer to produce gaseous ammonia;
delivering a first portion of the gaseous ammonia directly to an internal combustion engine;
delivering a second portion of the gaseous ammonia through an exhaust cracking unit and then through an electric cracking unit arranged in series;
during startup, energizing the electric cracking unit so that at least part of the second portion of the gaseous ammonia is cracked into a hydrogen-containing gas before the exhaust cracking unit reaches a threshold temperature suitable for ammonia cracking using exhaust heat;
supplying the hydrogen-containing gas to the internal combustion engine together with the first portion of the gaseous ammonia so that the internal combustion engine operates on ammonia and hydrogen-containing gas as co-fuels;
driving a generator with the internal combustion engine to produce electrical power;
monitoring exhaust temperature; and after the exhaust temperature exceeds the threshold temperature, utilizing the exhaust cracking unit for ammonia cracking and operating the internal combustion engine at a substantially constant operating speed while varying fuel delivery and air flow in response to changes in electrical load.

9. The method of claim 8, further comprising, before energizing the electric cracking unit, performing a system diagnostic check including one or more safety checks for pressure, level, leak, temperature, valve state, sensor status, or electrical readiness.

10. The method of claim 8, further comprising initiating a fast start system and using stored hydrogen for immediate engine crank before the electric cracking unit becomes a primary source of the hydrogen-containing gas during startup.

11. The method of claim 10, wherein initiating the fast start system includes energizing one or more of an engine oil heater, an oil pressure conditioning system, a coolant or water heater, an electric cracking unit pre-heater, and a circulation pump.

12. The method of claim 10, wherein, when the stationary power generation system is configured as a backup power system for a site that normally receives primary power from a utility grid, the fast start system is powered from the utility grid before startup, and one or more components of the fast start system are disengaged after the internal combustion engine is running.

13. The method of claim 8, further comprising charging a power supply for the electric cracking unit with an engine alternator after startup.

14. The method of claim 8, further comprising:
when exhaust temperature is below the threshold temperature during steady-state operation, increasing power to the electric cracking unit; and
when a power-supply state of charge is below a threshold, utilizing grid power or solar power to support the electric cracking unit or recharge a power supply associated with the electric cracking unit.

15. A skid-mounted generator system, comprising:
a skid base;
an internal combustion engine mounted on the skid base;
an alternator or generator head mounted on the skid base and mechanically coupled to the internal combustion engine;
an ammonia cracking system integrated with the skid-mounted generator system, the ammonia cracking system including an exhaust cracking unit and an electric cracking unit arranged in series;
an exhaust assembly operatively associated with the internal combustion engine and configured to direct exhaust gas from the internal combustion engine to the exhaust cracking unit for use in ammonia cracking;
an ammonia supply line configured to supply ammonia to the internal combustion engine;
a cracking-gas line configured to supply hydrogen-containing cracking gas from the ammonia cracking system to the internal combustion engine such that the internal combustion engine is configured to operate on ammonia and hydrogen-containing cracking gas as co-fuels; and
a control cabinet configured to coordinate operation of the internal combustion engine, the ammonia cracking system, and the alternator or generator head.

16. The skid-mounted generator system of claim 15, further comprising one or more vibration mounts disposed between the skid base and at least one of the internal combustion engine or the alternator or generator head.

17. The skid-mounted generator system of claim 15, further comprising a radiator or cooling assembly and coolant piping configured to circulate coolant to or from the internal combustion engine.

18. The skid-mounted generator system of claim 15, further comprising an electrical enclosure and electrical conduit coupling the alternator or generator head with the control cabinet or the electrical enclosure.

19. The skid-mounted generator system of claim 15, wherein a plurality of skid-mounted generator systems are electrically connected in parallel to a common bus, switchgear, paralleling panel, microgrid, or building distribution system to provide redundancy, scalability, or load sharing.

20. The skid-mounted generator system of claim 15, wherein a plurality of skid-mounted generator systems are arranged in a staged series configuration with a transfer device, static transfer switch, or UPS controller such that at least one secondary skid-mounted generator system assumes a critical load when a primary skid-mounted generator system becomes unavailable.
